(19) United States
(12) Patent Application Publication
(10) Pub. No.: US 2026/0014558 A1
(43) Pub. Date: Jan. 15, 2026

(54) MICROFLUIDIC APPARATUS WITH ELASTIC LAYERS AND CONTOURED SURFACE

(71) Applicant: Nutcracker Therapeutics, Inc., Emeryville, CA (US)

(72) Inventors: Sophia Ebright, El Cerrito, CA (US); Ximiao Wen, Hayward, CA (US); Babak Sanii, San Francisco, CA (US)

(21) Appl. No.: 19/333,818

(22) Filed: Sep. 19, 2025

Related U.S. Application Data
(63) Continuation of application No. PCT/US24/20488, filed on Mar. 19, 2024.
(60) Provisional application No. 63/453,206, filed on Mar. 20, 2023.

(51) Int. Cl. B01L 3/00

(52) U.S. Cl. CPC B01L 3/502707; B01L 2300/0809; B01L 2300/0861; B01L 2300/0887; B01L 2300/123

(57) ABSTRACT

A microfluidic apparatus includes a first plate, a second plate, and a microfluidic path defined between the first plate and the second plate. The microfluidic path includes at least one chamber. The microfluidic apparatus also includes an elastic layer disposed between the first plate and the second plate. The elastic layer includes a first membrane extending across the at least one chamber. The first membrane is configured to deflect to drive a fluid through the at least one chamber. The elastic layer also includes a second membrane having at least one aperture. The at least one aperture is aligned with the at least one chamber.

### PRIORITY

This application claims the benefit of U.S. Pat. App. No. 63/453,206, entitled “Microfluidic Apparatus with Elastic Layers and Contoured Surface,” filed Mar. 20, 2023, the disclosure of which is incorporated by reference herein.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

Some currently available technologies for manufacturing and formulating polynucleotide therapeutics (e.g., mRNA therapeutics, etc.) may expose the products to contamination and degradation. Some available centralized production may be too costly, too slow, or susceptible to contamination for use in therapeutic formulations possibly including multiple polynucleotide species.

### BRIEF DESCRIPTION OF THE DRAWINGS

The details of one or more implementations are set forth in the accompanying drawings and the description below. Other features, aspects, and advantages will become apparent from the description, the drawings, and the claims, in which:

FIG. 1 depicts a schematic view of an example of a system including a microfluidic process chip;

FIG. 2 depicts an exploded perspective view of examples of components of the system of FIG. 1;

FIG. 3 depicts a top plan view of an example of a process chip that may be incorporated into the system of FIG. 1;

FIG. 4A depicts a cross-sectional side view of the process chip of FIG. 3 in a first state of operation;

FIG. 4B depicts a cross-sectional side view of the process chip of FIG. 3 in a second state of operation;

FIG. 4C depicts a cross-sectional side view of the process chip of FIG. 3 in a third state of operation;

FIG. 4D depicts a cross-sectional side view of the process chip of FIG. 3 in a fourth state of operation;

FIG. 4E depicts a cross-sectional side view of the process chip of FIG. 3 in a fifth state of operation;

FIG. 4F depicts a cross-sectional side view of the process chip of FIG. 3 in a sixth state of operation;

FIG. 5 depicts a top plan view of another example of a process chip that may be incorporated into the system of FIG. 1;

FIG. 6 depicts an exploded perspective view of the process chip of FIG. 5, showing an elastic layer of the process chip including upper and lower membranes;

FIG. 7 depicts a top plan view of the lower membrane of the elastic layer of FIG. 6;

FIG. 8 depicts a top plan view of the upper membrane of the elastic layer of FIG. 6;

FIG. 9A depicts a cross-sectional side view of the process chip of FIG. 5 in a first state of operation, showing upper and lower regions of a valve chamber of the process chip having contoured surfaces;

FIG. 9B depicts a cross-sectional side view of the process chip of FIG. 5 in a second state of operation, showing the lower membrane of the elastic layer of FIG. 6 conforming to the contoured surface of the lower region of the valve chamber;

FIG. 9C depicts a cross-sectional side view of the process chip of FIG. 5 in a third state of operation, showing the lower membrane of the elastic layer of FIG. 6 conforming to the contoured surface of the upper region of the valve chamber;

FIG. 10 depicts an example of a method for designing the valve chamber of FIG. 9A; and

FIG. 11 depicts a cross-sectional side view of another example of a process chip that may be incorporated into the system of FIG. 1.

### DETAILED DESCRIPTION

In some aspects, apparatuses and methods are disclosed herein for processing therapeutic polynucleotides. In particular, these apparatuses and methods may be closed path apparatuses and methods that are configured to minimize or eliminate manual handling during operation. The closed path apparatuses and methods may provide a nearly entirely aseptic environment, and the components may provide a sterile path for processing from initial input (e.g., template) to output (e.g., compounded therapeutic). Material inputs (e.g., nucleotides, and any chemical components) into the apparatus may be sterile; and may be input into the system without requiring virtually any manual interaction.

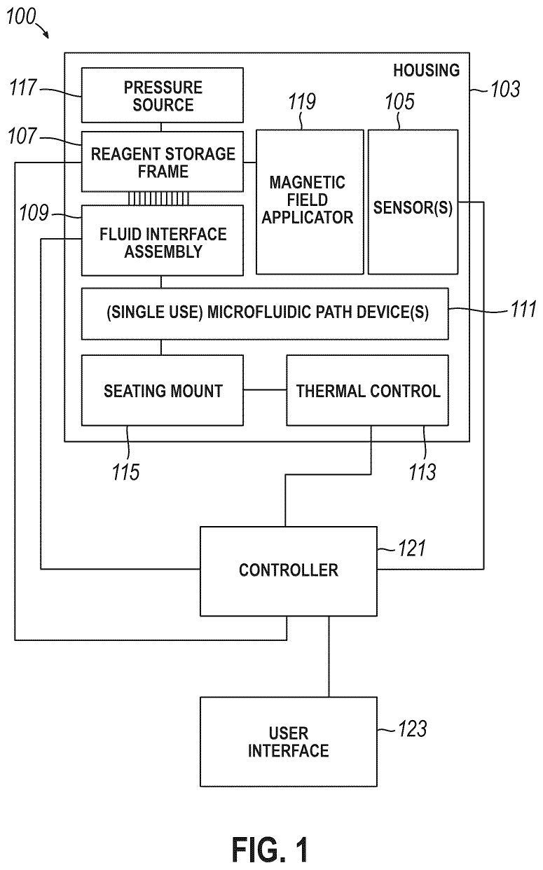

The apparatuses and methods described herein may be used to generate therapeutics at rapid cycle times at high degree of reproducibility. The apparatuses described herein may be configured to provide, in a single integrated apparatus, synthesis, purification, dialysis, compounding, and concentration of one or more therapeutic compositions. Alternatively, one or more of these processes may be carried out in two or more apparatuses as described herein. In some scenarios, the therapeutic compositions may include therapeutic polynucleotides, such as, for example, ribonucleic acids or deoxyribonucleic acids. The polynucleotides may include only natural nucleotide units or may include any kind of synthetic, semi-synthetic, or modified nucleotide units. All or some of the processing steps may be performed in an unbroken fluid processing pathway, which may be configured as one or a series of consumable microfluidic path device(s)—in some instances also referred to herein as a process chip or a biochip (though the chip need not necessarily be used in bio-related applications). The process chip in some examples may be removably installed in an instrument that is part of a larger microfluidic system, such as that shown in FIG. 1. The disclosed apparatuses and methods may be used for the synthesis of patient-specific therapeutics, including compounding, at a point of care (e.g., hospital, clinic, pharmacy, etc.).

### I. Terminology

Throughout this specification and the claims which follow, unless the context requires otherwise, the word “comprise,” and variations such as “comprises” and “comprising” means various components may be co-jointly employed in the methods and articles (e.g., compositions and apparatuses including device and methods). For example, the term “comprising” will be understood to imply the inclusion of any stated elements or steps but not the exclusion of any other elements or steps. In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components, or sub-steps.

As used herein, the singular forms “a,” “an,” and “the” are intended to include the plural forms as well, unless the context clearly indicates otherwise. As used herein, the term “and/or” includes any and all combinations of one or more of the associated listed items and may be abbreviated as “/”.

Spatially relative terms, such as “under,” “below,” “lower,” “over,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the term “under” may encompass both an orientation of over and under. The device may be otherwise oriented (rotated 90 degrees or at other orientations) and the spatially relative descriptors used herein interpreted accordingly. Similarly, the terms “upwardly,” “downwardly,” “vertical,” “horizontal,” and the like are used herein for the purpose of explanation only unless specifically indicated otherwise.

When a feature or element is herein referred to as being “on” another feature or element, it may be directly on the other feature or element or intervening features and/or elements may also be present. In contrast, when a feature or element is referred to as being “directly on” another feature or element, there are no intervening features or elements present. When a feature or element is referred to as being “connected,” “attached,” or “coupled” to another feature or element, it may be directly connected, attached, or coupled to the other feature or element or intervening features or elements may be present. In contrast, when a feature or element is referred to as being “directly connected,” “directly attached,” or “directly coupled” to another feature or element, there are no intervening features or elements present. Although described or shown with respect to one embodiment, the features and elements so described or shown may apply to other embodiments. It will also be appreciated by those skilled in the art that references to a structure or feature that is disposed “adjacent” another feature may have portions that overlap or underlie the adjacent feature.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is ±0.1% of the stated value (or range of values), ±1% of the stated value (or range of values), ±2% of the stated value (or range of values), ±5% of the stated value (or range of values), ±10% of the stated value (or range of values), etc. Any numerical values given herein should also be understood to include about or approximately that value unless the context indicates otherwise. For example, if the value “10” is disclosed, then “about 10” is also disclosed. Any numerical range recited herein is intended to include all sub-ranges subsumed therein.

It is also understood that when a value is disclosed that “less than or equal to” the value, “greater than or equal to the value,” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although the terms “first” and “second” may be used herein to describe various features/elements (including steps), these features/elements should not be limited by these terms, unless the context indicates otherwise. These terms are used to distinguish one feature/element from another feature/element, and unless specifically pointed out, do not denote a certain order. Thus, a first feature/element discussed below could be termed a second feature/element, and similarly, a second feature/element discussed below could be termed a first feature/element without departing from the teachings of the present invention.

As used herein, the terms “system,” “apparatus,” and “device” may be read as being interchangeable with each other. A system, apparatus, and device may each include a plurality of components having various kinds of structural and/or functional relationships with each other.

As used herein, “polynucleotide” refers to a nucleic acid molecule containing multiple nucleotides and generally refers both to “oligonucleotides” (a polynucleotide molecule of 18-25 nucleotides in length) and polynucleotides of 26 or more nucleotides. Aspects of this disclosure include compositions including oligonucleotides having a length of 18-25 nucleotides (e.g., 18-mers, 19-mers, 20-mers, 21-mers, 22-mers, 23-mers, 24-mers, or 25-mers), or medium-length polynucleotides having a length of 26 or more nucleotides (e.g., polynucleotides of 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, about 65, about 70, about 75, about 80, about 85, about 90, about 95, about 100, about 110, about 120, about 130, about 140, about 150, about 160, about 170, about 180, about 190, about 200, about 210, about 220, about 230, about 240, about 250, about 260, about 270, about 280, about 290, or about 300 nucleotides), or long polynucleotides having a length greater than about 300 nucleotides (e.g., polynucleotides of between about 300 to about 400 nucleotides, between about 400 to about 500 nucleotides, between about 500 to about 600 nucleotides, between about 600 to about 700 nucleotides, between about 700 to about 800 nucleotides, between about 800 to about 900 nucleotides, between about 900 to about 1000 nucleotides, between about 300 to about 500 nucleotides, between about 300 to about 600 nucleotides, between about 300 to about 700 nucleotides, between about 300 to about 800 nucleotides, between about 300 to about 900 nucleotides, or about 1000 nucleotides in length, or even greater than about 1000 nucleotides in length. Where a polynucleotide is double-stranded, its length may be similarly described in terms of base pairs.

As used herein “amplification” may refer to polynucleotide amplification. Amplification may include any suitable method for amplification of a polynucleotide and includes, but is not limited to, multiple displacement amplification (MDA), polymerase chain reaction (PCR) amplification, Loop Mediated Isothermal Amplification (LAMP), Nucleic Acid Sequence Based Amplification, Strand Displacement Amplification, Rolling Circle Amplification, and Ligase Chain Reaction.

As used herein a “cassette” (e.g., a synthetic in vitro transcription facilitator cassette) refers to a polynucleotide sequence which may include or be operably linked to one or more expression elements such as an enhancer, a promoter, a leader, an intron, a 5′ untranslated region (UTR), a 3′ UTR, or a transcription termination sequence. In some aspects, a cassette comprises at least a first polynucleotide sequence capable of initiating transcription of an operably linked second polynucleotide sequence (which may comprise a template) and optionally a transcription termination sequence operably linked to the second polynucleotide sequence. The template, as described below, may comprise a sequence of interest, for example, an open reading frame (“ORF”) of interest. The cassette may be provided as a single element or as two or more unlinked elements.

As used herein, a “template” refers to a nucleic acid sequence that contains a sequence of interest for preparing a therapeutic polynucleotide according to the disclosed methods. Templates may be, but are not limited to, a double stranded DNA (dsDNA), an engineered plasmid construct, a cDNA sequence, or a linear nucleic acid sequence (for example, a linear template generated by PCR or by annealing chemically synthesized oligonucleotides). The template may, in certain aspects, be integrated into a “cassette” as described above.

As used herein, the term “sequence of interest” refers to a polynucleotide sequence, the use of which may be deemed desirable for a suitable purpose, in particular, for the manufacture of an mRNA for a therapeutic use, and includes but is not limited to, coding sequences of structural genes, and non-coding regulatory sequences that do not encode and mRNA or protein product.

As used herein, “in vitro transcription” or “IVT” refer to the process whereby transcription occurs in vitro in a non-cellular system to produce synthetic RNA molecules (e.g., synthetic mRNA) for use in various applications, including for therapeutic delivery to a subject, for example, as a therapeutic polynucleotide, which may be part of, or may be used to form, a therapeutic polynucleotide composition as described below. The therapeutic polynucleotide, (e.g., synthetic RNA molecules (transcription product)) generated may be combined with a delivery vehicle to form a therapeutic polynucleotide composition. Synthetic transcription products include mRNAs, antisense RNA molecules, shRNA, circular RNA molecules, ribozymes, and the like. An IVT reaction may use a purified linear DNA template comprising a promoter sequence and the sequence of the open reading frame (ORF) of a sequence of interest, ribonucleotide triphosphates or modified ribonucleotide triphosphates, a buffer system that includes DTT and magnesium ions, and a phage RNA polymerase.

As used herein a “therapeutic polynucleotide” refers to a polynucleotide (e.g., an mRNA) that may be part of a therapeutic polynucleotide composition for delivery to a subject to treat a symptom, disease, or condition in a subject; prevent a symptom, disease, or condition in a subject; or to improve or otherwise modify the subject's health.

As used herein a “therapeutic polynucleotide composition” (or “therapeutic composition” for short) may refer to a composition including one or more therapeutic polynucleotides (e.g., mRNA) encapsulated by a delivery vehicle, which composition may be administered to a subject in need thereof using any suitable administration routes, such as intratumoral, intramuscular, etc. injection. An example of a therapeutic polynucleotide composition is an mRNA (therapeutic) nanoparticle comprising at least one mRNA encapsulated by a delivery vehicle molecule. An mRNA vaccine is one example of a therapeutic polynucleotide composition.

As used herein, “delivery vehicle” refers to any substance that facilitates, at least in part, the in vivo, in vitro, or ex vivo delivery of a polynucleotide (e.g., therapeutic polynucleotide) to targeted cells or tissues (e.g., tumors, etc.). Referring to something as a delivery vehicle need not exclude the possibility of the delivery vehicle also having therapeutic effects. Some versions of a delivery vehicle may provide additional therapeutic effects. In some versions, a delivery vehicle may be a peptoid molecule, such as an amino-lipidated peptoid molecule, that may be used to at least partially encapsulate mRNA. The term “DV” will also be used herein as a shorthand for “delivery vehicle.”

As used herein, “joining” refers to methods such as ligation, synthesis, primer extension, annealing, recombination, or hybridization use to couple one component to another.

As used herein “purifying” refers to physical and/or chemical separation of a component (e.g., particles) of other unwanted components (e.g., contaminating substances, fragments, etc.).

As used herein, the term “substantially free” as used with respect to a given substance, includes 100% free of a given substance, or which comprises less than about 1.0%, or less than about 0.5%, or less than about 0.1% of the given substance.

### II. Overview of System Including Microfluidic Process Chip

FIG. 1 depicts examples of various components that may be incorporated into a system (100). System (100) of this example includes a housing (103) enclosing a seating mount (115) that may removably hold one or more microfluidic process chips (111). In other words, system (100) includes a chip-receiving component that is configured to removably accommodate a process chip (111), where the process chip (111) itself defines one or more microfluidic channels or fluid pathways. Components of system (100) (e.g., within housing (103)) that fluidically interact with process chip (111) may include fluid channels or pathways that are not necessarily considered microfluidic (e.g., with such fluid channels or pathways being larger than the microfluidic channels or fluid pathways in process chip (111)). In some versions, process chips (111) are provided and utilized as single-use devices, while the rest of system (100) is reusable. Housing (103) may be in the form of a chamber, enclosure, etc., with an opening that may be closed (e.g., via a lid or door, etc.) to thereby seal the interior. Housing (103) may enclose a thermal regulator and/or may be configured to be enclosed in a thermally-regulated environment (e.g., a refrigeration unit, etc.). Housing (103) may form an aseptic barrier. In some variations, housing (103) may form a humidified or humidity-controlled environment. In addition, or in the alternative, system (100) may be positioned in a cabinet (not shown). Such a cabinet may provide a temperature-regulated (e.g., refrigerated) environment. Such a cabinet may also provide air filtering and air flow management and may promote reagents being kept at a desired temperature through the manufacturing process. In addition, such a cabinet may be equipped with UV lamps for sterilization of process chip (111) and other components of system (100). Other suitable features may be incorporated into a cabinet that houses system (100).

In some scenarios, the assembly formed by housing (103) and the components of system (100) that are within housing (103), without process chip (111), may be considered as being an “instrument.” While controller (121) and user interface (123) are shown in FIG. 1 as being outside of housing (103), controller (121) and user interface (123) may in fact be provided in or on housing (103) and may thus also form part of the instrument. As described in greater detail below, this instrument may removably receive process chip (111) via a seating mount (115). When process chip (111) is seated in seating mount (115), the instrument and process chip (111) cooperate to together form system (100). When process chip (111) is removed from seating mount (115), the portion of system (100) that is left may be regarded as the “instrument.” The instrument, the system (100), and process chip (111) may each be considered an “apparatus.” The term “apparatus” may thus be read to include the instrument by itself, a process chip (111) by itself, the combination of the instrument and process chip (111), some other combination of components of system (100), or some other permutation of system (100) or components thereof.

Seating mount (115) may be configured to secure process chip (111) using one or more pins or other components configured to hold process chip (111) in a fixed and predefined orientation. Seating mount (115) may thus facilitate process chip (111) being held at an appropriate position and orientation in relation to other components of system (100). In the present example, seating mount (115) is configured to hold process chip (111) in a horizontal orientation, such that process chip (111) is parallel with the ground.

In some variations, a thermal control (113) may be located adjacent to seating mount (115), to modulate the temperature of any process chip (111) mounted in seating mount (115). Thermal control (113) may include a thermoelectric component (e.g., Peltier device, etc.) and/or one or more heat sinks for controlling the temperature of all or a portion of any process chip (111) mounted in seating mount (115). In some variations, more than one thermal control (113) may be included, such as to separately regulate the temperature of different ones of one or more regions of process chip (111). Thermal control (113) may include one or more thermal sensors (e.g., thermocouples, etc.) that may be used for feedback control of process chip (111) and/or thermal control (113).

As shown in FIG. 1, a fluid interface assembly (109) couples process chip (111) with a pressure source (117), thereby providing one or more paths for fluid (e.g., gas) at a positive or negative pressure to be communicated from pressure source (117) to one or more interior regions of process chip (111) as will be described in greater detail below. While only one pressure source (117) is shown, system (100) may include two or more pressure sources (117). In some scenarios, pressure may be generated by one or more sources other than pressure source (117). For instance, one or more vials or other fluid sources within reagent storage frame (107) may be pressurized. In addition, or in the alternative, reactions and/or other processes carried out on process chip (111) may generate additional fluid pressure. In the present example, fluid interface assembly (109) also couples process chip (111) with a reagent storage frame (107), thereby providing one or more paths for liquid reagents, etc., to be communicated from reagent storage frame (107) to one or more interior regions of process chip (111) as will be described in greater detail below.

In some versions, pressurized fluid (e.g., gas) from at least one pressure source (117) reaches fluid interface assembly (109) via reagent storage frame (107), such that reagent storage frame (107) includes one or more components interposed in the fluid path between pressure source (117) and fluid interface assembly (109). In some versions, one or more pressure sources (117) are directly coupled with fluid interface assembly, such that the positively pressurized fluid (e.g., positively pressurized gas) or negatively pressurized fluid (e.g., suction or other negatively pressurized gas) bypasses reagent storage frame (107) to reach fluid interface assembly (109). Regardless of whether the fluid interface assembly (109) is interposed in the fluid path between pressure source (117) and fluid interface assembly (109), fluid interface assembly (109) may be removably coupled to the rest of system (100), such that at least a portion of fluid interface assembly (109) may be removed for sterilization between uses. As described in greater detail below, pressure source (117) may selectively pressurize one or more chamber regions on process chip (111). In addition, or in the alternative, pressure source may also selectively pressurize one or more vials or other fluid storage containers held by reagent storage frame (107).

Reagent storage frame (107) is configured to contain a plurality of fluid sample holders, each of which may hold a fluid vial that is configured to hold a reagent (e.g., nucleotides, solvent, water, etc.) for delivery to process chip (111). In some versions, one or more fluid vials or other storage containers in reagent storage frame (107) may be configured to receive a product from the interior of the process chip (111). In addition, or in the alternative, a second process chip (111) may receive a product from the interior of a first process chip (111), such that one or more fluids are transferred from one process chip (111) to another process chip (111). In some such scenarios, the first process chip (111) may perform a first dedicated function (e.g., synthesis, etc.) while the second process chip (111) performs a second dedicated function (e.g., encapsulation, etc.). Reagent storage frame (107) of the present example includes a plurality of pressure lines and/or a manifold configured to divide one or more pressure sources (117) into a plurality of pressure lines that may be applied to process chip (111). Such pressure lines may be independently or collectively (in sub-combinations) controlled.

Fluid interface assembly (109) may include a plurality of fluid lines and/or pressure lines where each such line includes a biased (e.g., spring-loaded) holder or tip that individually and independently drives each fluid and/or pressure line to process chip (111) when process chip (111) is held in seating mount (115). Any associated tubing (e.g., the fluid lines and/or the pressure lines) may be part of fluid interface assembly (109) and/or may connect to fluid interface assembly (109). In some versions, each fluid line comprises a flexible tubing that connects between reagent storage frame (107), via a connector that couples the vial to the tubing in a locking engagement (e.g., ferrule) and process chip (111). In some versions, the ends of the fluid lines/pressure lines may be configured to seal against process chip (111) (e.g., at a corresponding sealing port formed in process chip (111)), as described below. In the present example, the connections between pressure source (117) and process chip (111), and the connections between vials in reagent storage frame (107) and process chip (111), all form sealed and closed paths that are isolated when process chip (111) is seated in seating mount (115). Such sealed, closed paths may provide protection against contamination when processing therapeutic polynucleotides.

The vials of reagent storage frame (107) may be pressurized (e.g., >1 atm pressure, such as 2 atm, 3 atm, 5 atm, or higher). In some versions, the vials may be pressurized by pressure source (117). Negative or positive pressure may thus be applied. For example, the fluid vials may be pressurized to between about 1 and about 20 psig (e.g., 5 psig, 10 psig, etc.). Alternatively, a vacuum (e.g., about-7 psig or about 7 psia) may be applied to draw fluids back into the vials (e.g., vials serving as storage depots) at the end of the process. The fluid vials may be driven at lower pressure than the pneumatic valves as described below, which may prevent or reduce leakage. In some variations, the difference in pressure between the fluid and pneumatic valves may be between about 1 psi and about 25 psi (e.g., about 3 psi, about 5 psi, 7 psi, 10 psi, 12 psi, 15 psi, 20 psi, etc.).

System (100) of the present example further includes a magnetic field applicator (119), which is configured to create a magnetic field at a region of the process chip (111). Magnetic field applicator (119) may include a movable head that is operable to move the magnetic field to thereby selectively isolate products that are adhered to magnetic capture beads within vials or other storage containers in reagent storage frame (107).

System (100) of the present example further includes one or more sensors (105). In some versions, such sensors (105) include one or more cameras and/or other kinds of optical sensors. Such sensors (105) may sense one or more of a barcode, a fluid level within a fluid vial held within reagent storage frame (107), fluidic movement within a process chip (111) that is mounted within seating mount (115), and/or other optically detectable conditions. In versions where a sensor (105) is used to sense barcodes, such barcodes may be included on vials of reagent storage frame (107), such that sensor (105) may be used to identify vials in reagent storage frame (107). In some versions, a single sensor (105) is positioned and configured to simultaneously view such barcodes on vials in reagent storage frame (107), fluid levels in vials in reagent storage frame (107), fluidic movement within a process chip (111) that is mounted within seating mount (115), and/or other optically detectable conditions. In some other versions, more than one sensor (105) is used to view such conditions. In some such versions, different sensors (105) may be positioned and configured to separately view corresponding optically detectable conditions, such that a sensor (105) may be dedicated to a particular corresponding optically detectable condition.

In versions where sensors (105) include at least one optical sensor, visual/optical markers may be used to estimate yield. For example, fluorescence may be used to detect process yield or residual material by tagging with fluorophores. In addition, or in the alternative, dynamic light scattering (DLS) may be used to measure particle size distributions within a portion of the process chip (111) (e.g., such as a mixing portion of process chip (111)). In some variations, sensor (105) may provide measurements using one or two optical fibers to convey light (e.g., laser light) into process chip (111); and detect an optical signal coming out of process chip (111). In versions where sensor (105) optically detects process yield or residual material, etc., sensor (105) may be configured to detect visible light, fluorescent light, an ultraviolet (UV) absorbance signal, an infrared (IR) absorbance signal, and/or any other suitable kind of optical feedback.

In versions where sensors (105) include at least one optical sensor that is configured to capture video images, such sensors (105) may record at least some activity on process chip (111). For example, an entire run for synthesizing and/or processing a material (e.g., a therapeutic RNA) may be recorded by one or more video sensors (105), including a video sensor (105) that may visualize process chip (111) (e.g., from above). Processing on process chip (111) may be visually tracked and this video record may be retained for later quality control and/or processing. Thus, the video record of the processing may be saved, stored, and/or transmitted for subsequent review and/or analysis. In addition, as will be described in greater detail below, the video may be used as a real-time feedback input that may affect processing using at least visually observable conditions captured in the video.

System (100) of the present example may be controlled by a controller (121). Controller (121) may include one or more processors, one or more memories, and various other suitable electrical components. In some versions, one or more components of controller (121) (e.g., one or more processors, etc.) is/are embedded within system (100) (e.g., contained within housing (103)). In addition, or in the alternative, one or more components of controller (121) (e.g., one or more processors, etc.) may be detachably attached or detachably connected with other components of system (100). Thus, at least a portion of controller (121) may be removable. Moreover, at least a portion of controller (121) may be remote from housing (103) in some versions.

The control by controller (121) may include activating pressure source (117) to apply pressure through process chip (111) to drive fluidic movement, among other tasks. Controller (121) may be completely or partially outside of housing (103); or completely or partially inside of housing (103). Controller (121) may be configured to receive user inputs via a user interface (123) of system (100); and provide outputs to users via user interface (123). In some versions, controller (121) is fully automated to a point where user inputs are not needed. In some such versions, user interface (123) may provide only outputs to users. User interface (123) may include a monitor, a touchscreen, a keyboard, and/or any other suitable features. Controller (121) may coordinate processing, including moving one or more fluid(s) onto and on process chip (111), mixing one or more fluids on process chip (111), adding one or more components to process chip (111), metering fluid in process chip (111), regulating the temperature of process chip (111), applying a magnetic field (e.g., when using magnetic beads), etc. Controller (121) may receive real-time feedback from sensors (105) and execute control algorithms in accordance with such feedback from sensors (105). Such feedback from sensors (105) may include, but need not be limited to, identification of reagents in vials in reagent storage frame (107), detected fluid levels in vials in reagent storage frame (107), detected movement of fluid in process chip (111), fluorescence of fluorophores in fluid in process chip (111), etc. Controller (121) may include software, firmware and/or hardware. Controller (121) may also communicate with a remote server, e.g., to track operation of the apparatus, to re-order materials (e.g., components such as nucleotides, process chips (111), etc.), and/or to download protocols, etc.

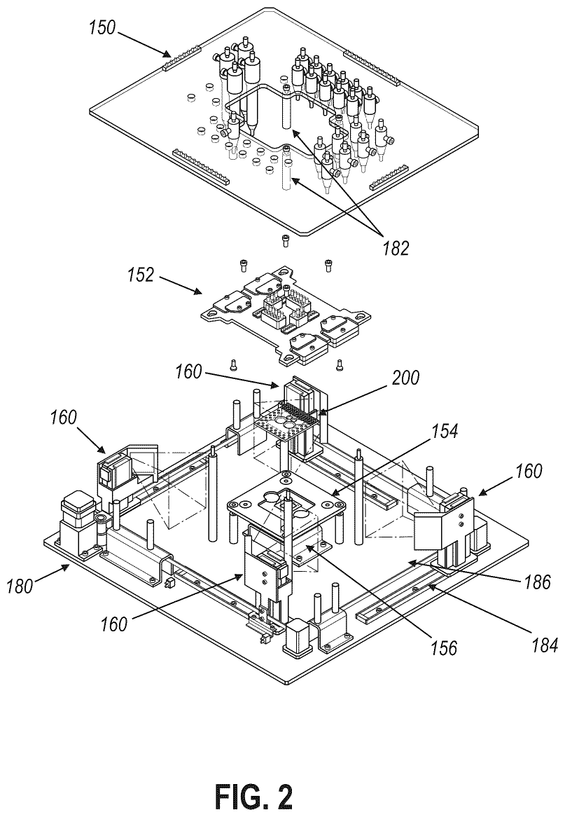

FIG. 2 shows examples of certain forms that may be taken by various components of system (100). In particular, FIG. 2 shows a reagent storage frame (150), a fluid interface assembly (152), a seating mount (154), a thermal control (156), and a process chip (200). Reagent storage frame (150), fluid interface assembly (152), seating mount (154), thermal control (156), and process chip (200) of this example may be configured and operable just like reagent storage frame (107), fluid interface assembly (109), seating mount (115), thermal control (113), and process chip (111), respectively, described above. These components are secured relative to a base (180). A set of rods (182) support reagent storage frame (150) over fluid interface assembly (152).

As shown in FIG. 2, a set of optical sensors (160) are positioned at four respective locations along base (180). Optical sensors (160) may be configured and operable like sensors (105) described above. Optical sensors (160) may include off-the-shelf cameras or any other suitable kinds of optical sensors. Optical sensors (160) are positioned such that fluid vials held within reagent storage frame (150) are within the field of view of one or more of optical sensors (160). In addition, process chip (200) is within the field of view of one or more of optical sensors (160). Each optical sensor (160) is movably secured to base (180) via a corresponding rail (184) (e.g., in a gantry arrangement), such that each optical sensor (160) is configured to translate laterally along each corresponding rail (184). A linear actuator (186) is secured to each optical sensor (160) and is thereby operable to drive lateral translation of each optical sensor (160) along the corresponding rail (184). Each actuator (186) may be in the form of a drive belt, a drive chain, a drive cable, or any other suitable kind of structure. Controller (121) may drive operation of actuators (186). Optical sensors (160) may be moved along rails (184) during operation of system (100) in order to facilitate viewing of the appropriate regions of vials in reagent storage frame (150) and/or process chip (200). In some scenarios, optical sensors (160) move in unison along corresponding rails (184). In some other scenarios, optical sensors (160) move independently along corresponding rails (184).

While optical sensors (160) are shown in FIG. 2 as being mounted to base (180), optical sensors (160) may be positioned elsewhere within system (100), in addition to or as an alternative to being mounted to base (180). For instance, some versions of reagent storage frame (107) may include one or more optical sensors (160) positioned and configured to provide an overhead field of view. In some such versions, such optical sensors (160) may be mounted to rails, movable cantilever arms, or other structures that allow such optical sensors (160) to be repositioned during operation of system (100). Optical sensors (160) may be positioned in any other suitable locations. While not shown, system (100) may also include one or more sources of light (e.g., electroluminescent panels, etc.) to provide illumination that aids in optical sensing by optical sensors (160).

In some versions, one or more mirrors are used to facilitate visualization of components of system (100) by optical sensors (160). Such mirrors may allow optical sensors (160) to view components of system (100) that may not otherwise be within the field of view of sensors (160). Such mirrors may be placed directly adjacent to optical sensors (160). In addition, or in the alternative, such mirrors may be placed adjacent to one or more components of system (100) that are to be viewed by optical sensors (160).

In use of system (100), an operator may select a protocol to run (e.g., from a library of preset protocols), or the user may enter a new protocol (or modify an existing protocol), via user interface (123). From the protocol, controller (121) may instruct the operator which kind of process chip (111) to use, what the contents of vials in reagent storage frame (107) should be, and where to place the vials in reagent storage frame (107). The operator may load process chip (111) into seating mount (115); and load the desired reagent vials and export vials into reagent storage frame (107). System (100) may confirm the presence of the desired peripherals, identify process chip (111), and scan identifiers (e.g., barcodes) for each reagent and product vial in reagent storage frame (107), facilitating the vials to match the bill-of-reagents for the selected protocol. After confirming the starting materials and equipment, controller (121) may execute the protocol. During execution, valves and pumps are actuated to deliver reagents as described in greater detail below, reagents are blended, temperature is controlled, and reactions occur, measurements are made, and products are pumped to destination vials in reagent storage frame (107).

### III. Example of Process Chip

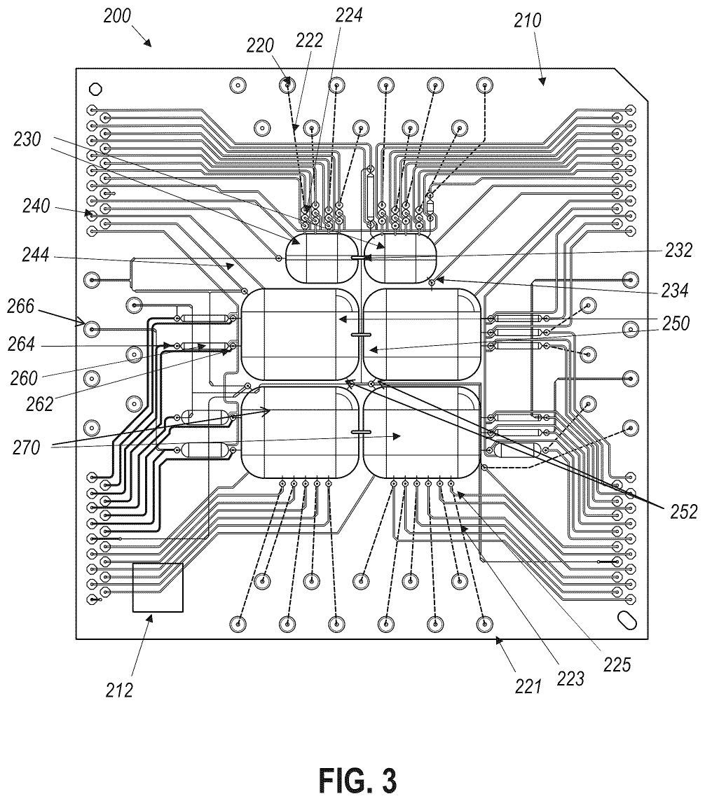

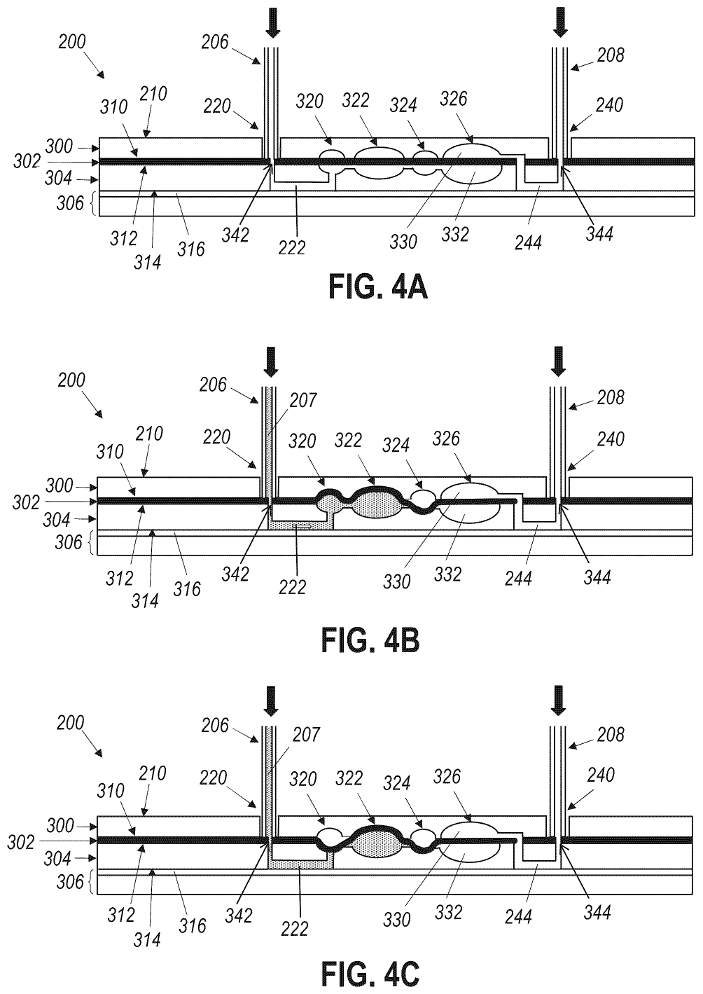

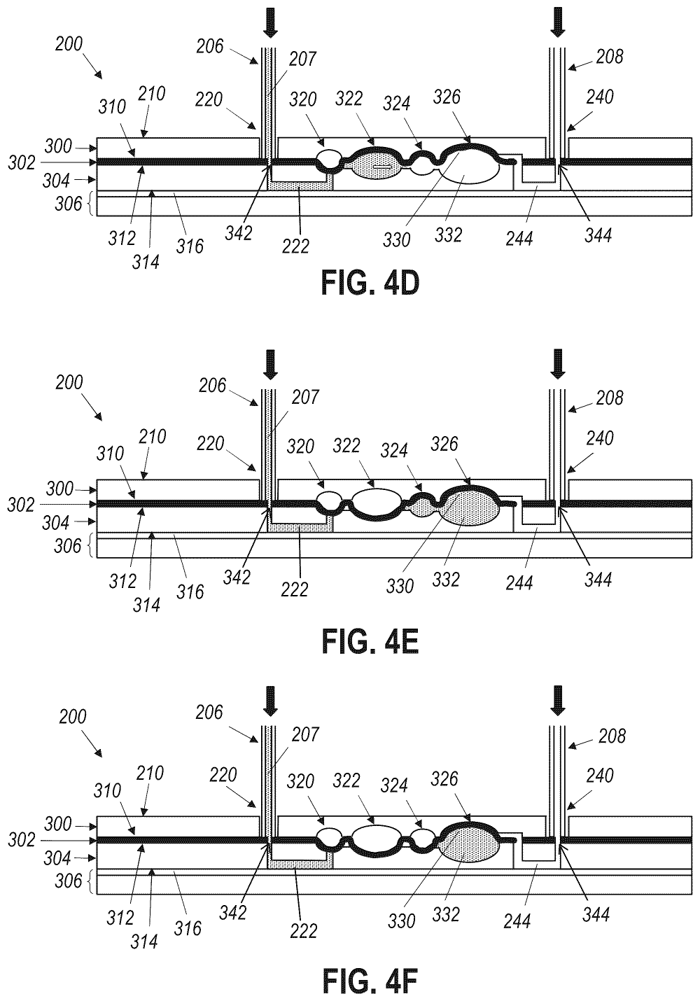

FIGS. 3 and 4A-4F depict the example of a process chip (200) in further detail. In combination with the rest of system (100), process chip (200) may be utilized to provide in-vitro synthesis, purification, concentration, formulation, and/or analysis of therapeutic compositions, including but not limited to therapeutic polynucleotides and therapeutic polynucleotide compositions. As shown in FIG. 3, process chip (200) of this example includes a plurality of fluid ports (220). Each fluid port (220) has an associated fluid channel (222) formed in process chip (200), such that fluid communicated into fluid port (220) will flow through the corresponding fluid channel (222). As described in greater detail below, each fluid port (220) is configured to receive fluid from a corresponding fluid line (206) from fluid interface assembly (109). In the present example, each fluid channel (222) leads to a valve chamber (224), which is operable to selectively prevent or permit fluid from the corresponding fluid channel (222) to be further communicated along process chip (200) as will be described in greater detail below.

As also shown in FIG. 3, process chip (200) of this example includes a plurality of additional chambers (230, 250, 270) that may be used to serve different purposes during the process of producing the therapeutic composition as described herein. By way of example only, such additional chambers (230, 250, 270) may be used to provide synthesis, purification, dialysis, compounding, and/or concentration of one or more therapeutic compositions; or to perform any other suitable function(s). Fluid may be communicated from one chamber (230) to another chamber (230) via a fluidic connector (232). In some versions, fluidic connector (232) is operable like a valve between an open and closed state (e.g., similar to valve chamber (224)). In some other versions, fluidic connector (232) remains open throughout the process of making the therapeutic composition. In the present example, chambers (230) are used to provide synthesis of polynucleotides, though chambers (230) may alternatively serve any other suitable purpose(s).

In the example shown in FIG. 3, another valve chamber (234) is interposed between one of chambers (230) and one of chambers (250), such that fluid may be selectively communicated from chamber (230) to chamber (250). Chambers (250) are provided in a pair and are coupled with each other such that process chip (200) may communicate the fluid back and forth between chambers (250). While a pair of chambers (250) are provided in the present example, any other suitable number of chambers (250) may be used, including just one chamber (250) or more than two chambers (250). Chambers (250) may be used to provide purification of the fluid and/or may serve any of the other various purposes described herein; and may have any suitable configuration. In versions where a chamber (250) is used for purification, chamber (250) may include a material that is configured to absorb selected moieties from a fluidic mixture in chamber (250). In some such versions, the material may include a cellulose material, which may selectively absorb double-stranded mRNA from a mixture. In some such versions, the cellulose material may be inserted in only one chamber (250) of a pair of chambers (250), such that upon mixing the fluid from the first chamber (250) of the pair to the second chamber (250), mRNA and/or some other component may be effectively removed from the fluidic mixture, which may then be transferred to another pair of chambers (270) further downstream for further processing or export. Alternatively, chambers (250) may be used for any other suitable purpose.

Additional valve chambers (252) are interposed between each chamber (250) and a corresponding chamber (270), such that fluid may be selectively communicated from chambers (250) to chambers (270) via valve chambers (252). Chambers (270) are also coupled with each other such that process chip (200) may communicate the fluid back and forth between chambers (270). Chambers (270) may be used to provide mixing of the fluid and/or may serve any of the other various purposes described herein; and may have any suitable configuration.

As shown in FIG. 3, chambers (270) are also coupled with additional fluid ports (221) via corresponding fluid channels (223) and valve chambers (225). Fluid ports (221), fluid channels (223), and valve chambers (225) may be configured and operable like fluid ports (220), fluid channels (222), and valve chambers (224) described above. In some versions, fluid ports (221) are used to communicate additional fluids to chambers (270). In addition, or in the alternative, fluid ports (221) may be used to communicate fluid from process chip (200) to another device. For instance, fluid from chambers (270) may be communicated via fluid ports (221) directly to another process chip (200), to one or more vials in reagent storage frame (107), or elsewhere.

Process chip (200) further includes several reservoir chambers (260). In this example, each reservoir chamber (260) is configured to receive and store fluid that is being communicated to or from a corresponding chamber (250, 270). Each reservoir chamber (260) has a corresponding inlet valve chamber (262) and outlet valve chamber (264). Each inlet valve chamber (262) is interposed between reservoir chamber (260) and the corresponding chamber (250, 270) and is thereby operable to permit or prevent the flow of fluid between reservoir chamber (260) and the corresponding chamber (250, 270). Each outlet valve chamber (264) is operable to meter the flow of fluid between reservoir chamber (260) and a corresponding fluid port (266). In some versions, each fluid port (266) is configured to communicate fluid from a corresponding vial in reagent storage frame (107) to a corresponding reservoir chamber (260). In addition, or in the alternative, each fluid port (266) may be configured to communicate fluid from a corresponding reservoir chamber (260) to a corresponding vial in reagent storage frame (107). In the present example, reservoir chambers (260) are used to provide metering of fluid communicated to and/or from process chip (200). Alternatively, reservoir chambers (260) may be utilized for any other suitable purposes, including but not limited to pressurizing fluid that is communicated to and/or from process chip (200).

As also shown in FIG. 3, process chip (200) of this example includes a plurality of pressure ports (240). Each pressure port (240) has an associated pressure channel (244) formed in process chip (200), such that pressurized gas communicated through pressure port (240) will be further communicated through the corresponding pressure channel (244). As described in greater detail below, each pressure port (240) is configured to receive pressurized gas from a corresponding pressure line (208) from fluid interface assembly (109). In the present example, each pressure channel (244) leads to a corresponding chamber (224, 225, 230, 234, 250, 252, 260, 262, 264, 270) to thereby provide valving or peristaltic pumping via such chambers (224, 225, 230, 234, 250, 252, 260, 262, 264, 270) as described in greater detail below.

Process chip (200) may also include electrical contacts, pins, pin sockets, capacitive coils, inductive coils, or other features that are configured to provide electrical communication with other components of system (100). In the example shown in FIG. 3, process chip (200) includes an electrically active region (212) that includes such electrical communication features. Electrically active region (212) may further include electrical circuits and other electrical components. In some versions, electrically active region (212) may provide communication of power, data, etc. While electrically active region (212) is shown in one particular location on process chip, electrically active region (212) may alternatively be positioned at any other suitable location or locations. In some versions, electrically active region (212) is omitted.

As shown in FIGS. 4A-4F, process chip (200) further includes a first plate (300), an elastic layer (302), a second plate (304), and a third plate (306). As described in greater detail below, some versions of elastic layer (302) are in the form of a flexible membrane. First plate (300) has an upper surface (210) and a lower surface (310), with lower surface (310) apposing elastic layer (302). Second plate (304) has an upper surface (312) and a lower surface (314), with upper surface (312) apposing elastic layer (302); and with lower surface (314) apposing third plate (306). Elastic layer (302) is thus interposed between first and second plates (300, 304). In the present example, another elastic layer (316) is also interposed between second and third plates (304, 306), though this elastic layer (316) is optional.

Plates (300, 304, 306) of the present example are substantially translucent to visible light and/or ultraviolet light. By “substantially translucent” is meant that at least 90% (including in some instances 100%) of light is transmitted through the material compared to a translucent material. In some variations, the one or more of plates (300, 304, 306) may comprise materials that are substantially transparent to visible light and/or ultraviolet light. By “substantially transparent” is meant that at least 90% (including in some instances 100%) of light is transmitted through the material compared to a completely transparent material. As another example, one or more of plates (300, 304, 306) may provide transmission of ultraviolet light at a wavelength of approximately 260 nm at a transmission rate ranging from approximately 0.2% to approximately 20%, including from approximately 0.4% to approximately 15%, or including from approximately 0.5% to approximately 10%.

Plates (300, 304, 306) of the present example are also rigid. In some other versions, one or more of plates (300, 304, 306) are semi-rigid. Plates (300, 304, 306) may comprise glass, plastic, silicone, and/or any other suitable material(s). In some versions, one or more of plates (300, 304, 306) is formed as a lamination of two or more layers of material, such that each plate (300, 304, 306) does not necessarily need to be formed as a single homogenous continuum of material. The material(s) comprising one of plates (300, 304, 306) may also differ from the material(s) comprising other plates (300, 304, 306).

Elastic layer (302) of the present example is formed as a liquid-impermeable flexible membrane. In some versions, elastic layer (302) is gas-permeable despite being liquid-impermeable. In some such versions, certain regions of elastic layer (302) are treated to be gas-permeable while the non-treated regions of elastic layer (302) are gas-impermeable. As described below, elastic layer (302) may be used to drive fluids across process chip (200) via peristaltic pumping action. As also described below, elastic layer (302) may be used to provide valves at various locations along process chip (200). In some versions, a single sheet of elastic material spans across the width of process chip (200) to form elastic layer (302). In some other versions, two or more discrete pieces of elastic material are used to form elastic layer (302), with such discrete pieces of elastic material being positioned at different locations across the width of process chip (200). By way of example only, elastic layer (302) may include a membrane comprising polydimethylsilicone (PDMS) elastomer film.

As best seen in FIGS. 4A-4F, first and second plates (300, 304) cooperate to define a plurality of chambers (320, 322, 324, 326), with elastic layer (302) bisecting each chamber (320, 322, 324, 326) into a corresponding upper chamber region (330) and lower chamber region (332). Chambers (224, 225, 230, 234, 250, 252, 260, 262, 264, 270) shown in FIG. 3 may be configured and operable just like chambers (320, 322, 324, 326) shown in FIGS. 4A-4F. For instance, chamber (320) may be analogous to chamber (264), chamber (322) may be analogous to chamber (260), chamber (324) may be analogous to chamber (262), and chamber (326) may be analogous to chamber (250).

As shown in FIGS. 4A-4F, fluid port (220) is formed through first plate (300). A corresponding opening (342) is formed through the region of elastic layer (302) underlying fluid port (220). Fluid channel (222) extends from opening (342) to lower chamber region (332) of first chamber (320). As noted above, fluid port (220) is configured to receive a fluid line (206) from fluid interface assembly (109). The distal end of fluid line (206) is configured to seal against the region of elastic layer (302) that is exposed by fluid port (220) and communicate fluid (207) through opening (342). In some versions, a spring or other resilient member provides a resilient bias to fluid line (206), urging the distal end of fluid line (206) against the region of elastic layer (302) that is exposed by fluid port (220) to thereby maintain the seal. Fluid (207) from fluid line (206) reaches lower chamber region (332) of first chamber (320) via fluid channel (222). As described in greater detail below, this fluid (207) may be further communicated from first chamber (320) to other chambers (322, 324, 326) through a peristaltic pumping action that is provided via elastic layer (302). After reaching fourth chamber (326), the fluid (207) may be further communicated to other chambers or other features in process chip (200), may be communicated to a storage vial in reagent storage frame (107), or may be otherwise processed. The path for fluid (207) thus does not necessarily terminate at fourth chamber (326). It should also be understood that any of the other fluid ports (221, 266) shown in FIG. 3 may be configured and operable like fluid port (220) shown in FIGS. 4A-4F.

Pressure port (240) is formed through first plate (300). A corresponding opening (344) is formed through the region of elastic layer (302) underlying pressure port (240). Pressure channel (244) extends from opening (344) to upper chamber region (330) of first chamber (320). As noted above, pressure port (240) is configured to receive a pressure line (208) from fluid interface assembly (109), to thereby receive pressurized gas from pressure source (117). The distal end of pressure line (208) is configured to seal against the region of elastic layer (302) that is exposed by pressure port (240) and communicate either positively pressurized gas or negatively pressurized gas through opening (344). In some versions, a spring or other resilient member provides a resilient bias to pressure line (208), urging the distal end of pressure line (208) against the region of elastic layer (302) that is exposed by pressure port (240) to thereby maintain the seal. Positively pressurized gas or negatively pressurized gas from pressure line (208) reaches upper chamber region (330) of fourth chamber (326) via pressure channel (244).

While FIGS. 4A-4F depict just one pressure line (208) being coupled with process chip (200), process chip (200) may have several coupled pressure lines (208), with such pressure lines (208) independently applying positive or negative pressure to corresponding chambers (320, 322, 324, 326) of process chip (200). In some versions, one or more of chambers (320, 322, 324, 326) has its own dedicated pressure line (208) and corresponding pressure channel (244). In addition, or in the alternative, one or more of chambers (320, 322, 324, 326) may share a common pressure line (208), via the same pressure channel (244) or via separate pressure channels (244). While FIGS. 4A-4F depict pressure channel (244) formed through second plate (304), some pressure channels (244) (or regions of pressure channels (244)) may be formed by first plate (300). For instance, some pressure channels (244) (or regions of pressure channels (244)) may be formed between a recess in the lower surface of first plate (300) and the top surface of elastic layer (302).

### IV. Example of Valving and Peristaltic Pumping Driven Via Elastic Layer

As noted above, elastic layer (302) may be operated to drive fluid through process chip (200) through a peristaltic pumping action; and to arrest movement of fluid through process chip (200) by providing a valving action. An example of such operation is illustrated in the sequence depicted through FIGS. 4A-4F. In this example, chambers (320, 324) serve as valve chambers, while chamber (322) serves as a metering chamber. Chamber (326) serves as a working chamber, such that synthesis, purification, dialysis, compounding, concentration, or some other process is performed in chamber (326). This configuration, arrangement, and usage of chambers (320, 322, 324, 326) is provided as an illustrative example. Chambers (320, 322, 324, 326) may alternatively be configured, arranged, and used in other ways.

FIG. 4A shows process chip (200) in a state where fluid is not yet being communicated to process chip (200); and pressurized gas is not yet being communicated to process chip (200). In FIG. 4B, positively pressurized gas is communicated to upper chamber region (330) of chamber (324), negatively pressurized gas is communicated to upper regions (330) of chambers (320, 322), and fluid (207) is communicated to chambers (320, 322). In this state, the positively pressurized gas deforms the portion of elastic layer (302) in chamber (324) such that elastic layer (302) seats against the surface of lower chamber region (332) of chamber (324). This seating of elastic layer (302) against the surface of lower chamber region (332) of chamber (324) prevents fluid (207) from entering chamber (324), such that chamber (324) is operating like a closed valve in the state shown in FIG. 4B. The negatively pressurized gas in upper chamber regions (330) of chambers (320, 322) causes the corresponding portion of elastic layer (302) in chambers (320, 322) to deform and seat against upper chamber regions (330) of chambers (320, 322). This allows fluid (207) to occupy the full capacity of chambers (320, 322).

After reaching the state shown in FIG. 4B, positively pressurized gas is communicated to upper chamber region (330) of chamber (320) while the pneumatic state of chambers (322, 324) may remain unchanged. This results in the state shown in FIG. 4C. As shown, the positively pressurized gas deforms the portion of elastic layer (302) in chamber (320) such that elastic layer (302) seats against the surface of lower chamber region (332) of chamber (320). This seating of elastic layer (302) against the surface of lower chamber region (332) of chamber (320) drives the fluid (207) out from chamber (320) and results in chamber (320) operating like a closed valve in the state shown in FIG. 4C. However, the volume of fluid (207) in chamber (322) is unaffected in the state shown in FIG. 4C. Chamber (322) may thus be used to provide metering of fluid (207), such that only a precise, predetermined volume of fluid (207) is communicated further along process chip (200). By way of example only, such metered volumes may be on the order of approximately 10 nL, 20 nL, 25 nL, 50 nL, 75 nL, 100 nL, 1 microliter, 5 microliters, etc.

Once the appropriate metering volume has been achieved, negatively pressurized gas is communicated to upper chamber regions (330) of chambers (324, 326) while the pneumatic state of chambers (320, 322) may remain unchanged. This results in the state shown in FIG. 4D. As shown, the negatively pressurized gas in upper chamber regions (330) of chambers (324, 326) causes the corresponding portion of elastic layer (302) in chamber (324, 326) to deform and seat against the surface of upper chamber regions (330) of chambers (324, 326). This effectively opens the valve formed by chamber (324) and puts chamber (326) in a state to receive fluid (207). This also produces a negative pressure in chamber (324) that draws fluid (207) from chamber (322) into chamber (324).

With the valve formed by chamber (324) being in the open state, positively pressurized gas is communicated to upper chamber region (330) of chamber (322) while the pneumatic state of chambers (320, 324, 326) may remain unchanged. This results in the state shown in FIG. 4E. As shown, the positively pressurized gas in upper chamber region (330) of chamber (322) causes the corresponding portion of elastic layer (302) in chamber (322) to deform and seat against the surface of lower chamber region (332) of chamber (322). This deformation of elastic layer (302) drives fluid (207) out of chamber (322). Since the valve formed by chamber (320) is in a closed state and the valve formed by chamber (324) is in an open state, fluid (207) travels from chamber (322) into chamber (324). In the present example, the capacity of chamber (322) is greater than the capacity of chamber (324), such that fluid (207) from chamber (322) overflows from chamber (324) into chamber (326).

Once fluid (207) has been communicated from chamber (322) to chambers (324, 326), positively pressurized gas is communicated to upper chamber region (330) of chamber (324) while the pneumatic state of chambers (320, 322, 326) may remain unchanged. This results in the state shown in FIG. 4F. As shown, the positively pressurized gas in upper chamber region (330) of chamber (324) causes the corresponding portion of elastic layer (302) in chamber (324) to deform and seat against the surface of lower chamber region (332) of chamber (324). This deformation of elastic layer (302) drives fluid (207) out of chamber (324). Since the deformed portion of elastic layer (302) in chamber (324) is effectively sealing off chamber (324) from chamber (322) (e.g., such that chamber (324) is operating like a valve in a closed state), fluid (207) travels from chamber (324) into chamber (326).

At the stage shown in FIG. 4F, fluid (207) has been evacuated from chambers (320, 332, 324), and chamber (326) contains the volume of fluid (207) that was precisely metered in chamber (322). Fluid (207) in chamber (326) may be further processed within chamber (326) in accordance with the teachings herein. In addition, or in the alternative, fluid (207) in chamber (326) may be communicated to one or more other chambers in process chip (200), may be communicated to a vial in reagent storage frame (107), or may be otherwise handled. Regardless of what is done with fluid (207) after fluid (207) has reached chamber (326), it should be understood that fluid (207) was communicated along chambers (320, 322, 324), in a sequence, to reach chamber (326) via a peristaltic action created through elastic layer (302) in response to positively pressurized gas or negatively pressurized gas being communicated to upper chamber regions (330) of chambers (320, 322, 324, 326) in a particular sequence. Such peristaltic pumping may have particular advantage for moving fluid that may be viscous or contain suspended particles such as purification or capture beads. Such peristaltic pumping through selective deformation of elastic layer (302) may also be referred to as pneumatic barrier deflection or “pneumodeflection.”

In some scenarios, it may be desirable to remove air or other gas from one or more fluid pathways in process chip (200). To accomplish this, process chip (200) may include one or more chambers that are configured to provide ventilation of a fluid pathway or otherwise evacuate gas from the fluid pathway. For instance, such ventilation or evacuation may be performed as part of a priming process as fluid is initially introduced to process chip (200). In addition, or in the alternative, such ventilation or evacuation may be performed to relieve gas that is generated in the fluid during the process of forming the therapeutic composition. Such ventilation or gas relief chambers may be referred to as “vacuum caps.” In some versions, at least the region of elastic layer (302) that is positioned in the vacuum cap (if not the entirety of elastic layer (302)) is gas permeable (while still being liquid impermeable). Negatively pressurized gas may be applied to the upper chamber region (330) of the chamber that is being used as a vacuum cap, and this negatively pressurized gas may draw the air or gas from the fluid pathway out through the corresponding region of elastic layer (302). In some versions, the upper chamber region (330) of the chamber that is being used as a vacuum cap includes one or more projections or stand-off features that prevent the corresponding region of elastic layer (302) from fully seating against the surface of the upper chamber region (330) of the chamber that is being used as a vacuum cap. This may further promote evacuation of air or other gas via the vacuum cap.

V. Example of Process Chip with Improved Pumping/Valving Features

As noted above, elastic layer (302) is interposed between first and second plates (300, 304) and may be used to drive fluids across process chip (200) via peristaltic pumping action and/or to provide valves at various locations along process chip (200). In some scenarios, it may be desirable to provide elastic layer (302) with an increased thickness, such as in the regions of elastic layer (302) that are bonded to first and/or second plates (300, 304). For example, an increased thickness of elastic layer (302) in such regions may provide an improved seal between such regions of elastic layer (302) and one or both of first and/or second plates (300, 304). In other words, a desire to enhance the effectiveness of the seal at the interfaces between elastic layer (302) and plates (300, 304) may drive a tendency to increase the thickness of elastic layer (302). In addition, or alternatively, an increased thickness of elastic layer (302) may provide reduced diffusion of air (or other gas) in situations where such diffusion of air (or other gas) is not needed or otherwise desired, such as when the valves are closed.

It may also be desirable to provide elastic layer (302) with a minimal thickness, such as in the regions of elastic layer (302) that are disposed within any of chambers (320, 322, 324, 326). For example, a decreased thickness of elastic layer (302) in such regions may provide an improved response of such regions of elastic layer (302) to pneumatic pressure, such as by allowing such regions of elastic layer (302) to more closely conform to the surface(s) of the upper and/or lower chamber regions (330, 332) of the respective chamber (320, 322, 324, 326) and thereby more fully seat against such surface(s) in response to pneumatic pressure (e.g., provided via pressure line (208)). In other words, a desire to enhance the effectiveness of valving and peristaltic pumping through deformation of elastic layer (302) may drive a tendency to reduce the thickness of elastic layer (302). In addition, or alternatively, a decreased thickness of elastic layer (302) in such regions may provide improved diffusion of air (or other gas) in situations where such diffusion of air (or other gas) is needed or otherwise desired, such as during priming as fluid is initially introduced to process chip (200) and/or during evacuation of air or other gas via a vacuum cap. This tendency to reduce the thickness of elastic layer (302) (to enhance the effectiveness of valving and peristaltic pumping) may tend to conflict with the above-noted tendency to increase the thickness of elastic layer (302) (to enhance the seal at the interfaces). These competing desires and tendencies may therefore warrant a compromise that effectively achieves both desires simultaneously. An example of how such a compromise may be achieved is described in greater detail below.

In addition, or alternatively, it may be desirable to provide the surface(s) of the upper and/or lower chamber regions (330, 332) of chamber (320, 322, 324, 326) with a different shape. For example, it may be desirable to provide such surface(s) with a shape that provides improved manufacturability of the respective plate(s) (300, 304), such as by enabling molding of the respective plate(s) (300, 304). As another example, it may be desirable to provide such surface(s) with a shape that provides an improved pneumatic pressure response to the regions of elastic layer (302) that are disposed within chambers (320, 322, 324, 326), such as by allowing such regions to more closely conform to such surface(s) and thereby more fully seat against such surface(s) in response to pneumatic pressure (e.g., provided via pressure line (208)), while reducing or eliminating any contortion of such regions of elastic layer (302) by such surface(s) of chamber regions (330, 332).

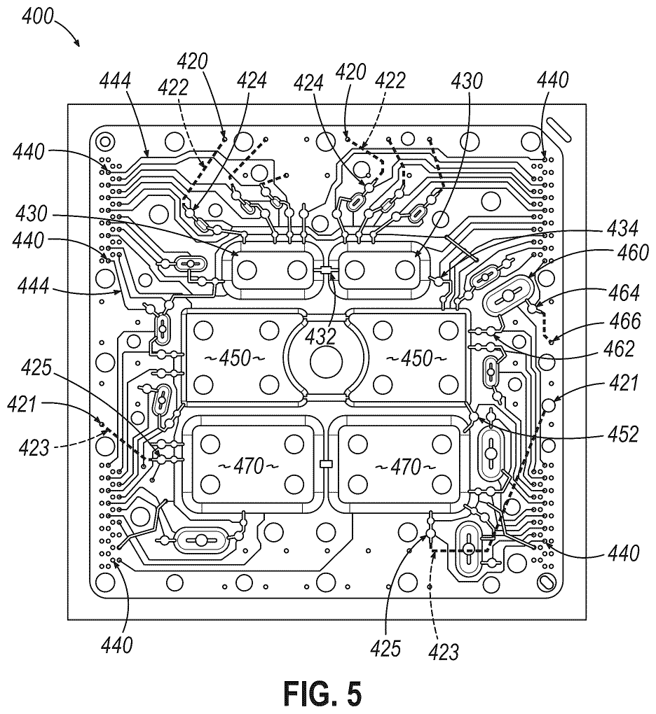

FIGS. 5-9B show an example of a process chip (400) that may provide the features and functionalities described above. Process chip (400) is similar to process chip (200) described above, except as otherwise described below. In this regard, in combination with the rest of system (100), process chip (400) may be utilized to provide in-vitro synthesis, purification, concentration, formulation (e.g., encapsulation of a therapeutic composition in a delivery vehicle through a mixing process, etc.), and/or analysis of therapeutic compositions, including but not limited to therapeutic polynucleotides and therapeutic polynucleotide compositions. As shown in FIG. 5, process chip (400) of this example includes a plurality of fluid ports (420). Each fluid port (420) has an associated fluid channel (422) formed in process chip (400), such that fluid communicated into fluid port (420) will flow through the corresponding fluid channel (422). As described in greater detail below, each fluid port (420) is configured to receive fluid from a corresponding fluid line (206) from fluid interface assembly (109). In the present example, each fluid channel (422) leads to a valve chamber (424), which is operable to selectively prevent or permit fluid from the corresponding fluid channel (422) to be further communicated along process chip (400) as will be described in greater detail below.

As also shown in FIG. 5, process chip (400) of this example includes a plurality of additional chambers (430, 450, 470) that may be used to serve different purposes during the process of producing the therapeutic composition as described herein. By way of example only, such additional chambers (430, 450, 470) may be used to provide synthesis, purification, dialysis, compounding, and/or concentration of one or more therapeutic compositions; or to perform any other suitable function(s). Fluid may be communicated from one chamber (430) to another chamber (430) via a fluidic connector (432). In some versions, fluidic connector (432) is operable like a valve between an open and closed state (e.g., similar to valve chamber (424)). In some other versions, fluidic connector (432) remains open throughout the process of making the therapeutic composition. In the present example, chambers (430) are used to provide synthesis of polynucleotides, though chambers (430) may alternatively serve any other suitable purpose(s).

In the example shown in FIG. 5, another valve chamber (434) is interposed between one of chambers (430) and one of chambers (450), such that fluid may be selectively communicated from chamber (430) to chamber (450). Chambers (450) are provided in a pair and are coupled with each other such that process chip (400) may communicate the fluid back and forth between chambers (450). While a pair of chambers (450) are provided in the present example, any other suitable number of chambers (450) may be used, including just one chamber (450) or more than two chambers (450). Chambers (450) may be used to provide purification of the fluid and/or may serve any of the other various purposes described herein; and may have any suitable configuration.

In versions where a chamber (450) is used for purification, chamber (450) may include a material that is configured to absorb selected moieties from a fluidic mixture in chamber (450). In some such versions, the material may include a cellulose material, which may selectively absorb double-stranded mRNA from a mixture. In some such versions, the cellulose material may be inserted in only one chamber (450) of a pair of chambers (450), such that upon mixing the fluid from the first chamber (450) of the pair to the second chamber (450), mRNA and/or some other component may be effectively removed from the fluidic mixture, which may then be transferred to another pair of chambers (470) further downstream for further processing or export. Alternatively, chambers (450) may be used for any other suitable purpose.

At least one additional valve chamber (452) is interposed between at least one chamber (450) and a corresponding chamber (470), such that fluid may be selectively communicated from chambers (450) to chambers (470) via valve chambers (452). Chambers (470) are also coupled with each other such that process chip (400) may communicate the fluid back and forth between chambers (470). Chambers (470) may be used to provide mixing of the fluid and/or may serve any of the other various purposes described herein; and may have any suitable configuration.

As shown in FIG. 5, chambers (470) are also coupled with additional fluid ports (421) via corresponding fluid channels (423) and valve chambers (425). Fluid ports (421), fluid channels (423), and valve chambers (425) may be configured and operable like fluid ports (420), fluid channels (422), and valve chambers (424) described above. In some versions, fluid ports (421) are used to communicate additional fluids to chambers (470). In addition, or in the alternative, fluid ports (421) may be used to communicate fluid from process chip (400) to another device. For instance, fluid from chambers (470) may be communicated via fluid ports (421) directly to another process chip (400), to one or more vials in reagent storage frame (107), or elsewhere.

Process chip (400) further includes several reservoir chambers (460). In this example, each reservoir chamber (460) is configured to receive and store fluid that is being communicated to or from a corresponding chamber (450, 470). Each reservoir chamber (460) has a corresponding inlet valve chamber (462) and outlet valve chamber (464). Each inlet valve chamber (462) is interposed between reservoir chamber (460) and the corresponding chamber (450, 470) and is thereby operable to permit or prevent the flow of fluid between reservoir chamber (460) and the corresponding chamber (450, 470). Each outlet valve chamber (464) is operable to meter the flow of fluid between reservoir chamber (460) and a corresponding fluid port (466). In some versions, each fluid port (466) is configured to communicate fluid from a corresponding vial in reagent storage frame (107) to a corresponding reservoir chamber (460). In addition, or in the alternative, each fluid port (466) may be configured to communicate fluid from a corresponding reservoir chamber (460) to a corresponding vial in reagent storage frame (107). In the present example, reservoir chambers (460) are used to provide metering of fluid communicated to and/or from process chip (400). Alternatively, reservoir chambers (460) may be utilized for any other suitable purposes, including but not limited to pressurizing fluid that is communicated to and/or from process chip (400).

As also shown in FIG. 5, process chip (400) of this example includes a plurality of pressure ports (440). Each pressure port (440) has an associated pressure channel (444) formed in process chip (400), such that positively pressurized gas and/or negatively pressurized gas (e.g., vacuum) communicated through pressure port (440) will be further communicated through the corresponding pressure channel (444). As described in greater detail below, each pressure port (440) is configured to receive pressurized gas from a corresponding pressure line (408) from fluid interface assembly (109). In the present example, each pressure channel (444) leads to a corresponding chamber (424, 425, 430, 434, 450, 452, 460, 462, 464, 470) to thereby provide valving or peristaltic pumping via such chambers (424, 425, 430, 434, 450, 452, 460, 462, 464, 470) as described in greater detail below.

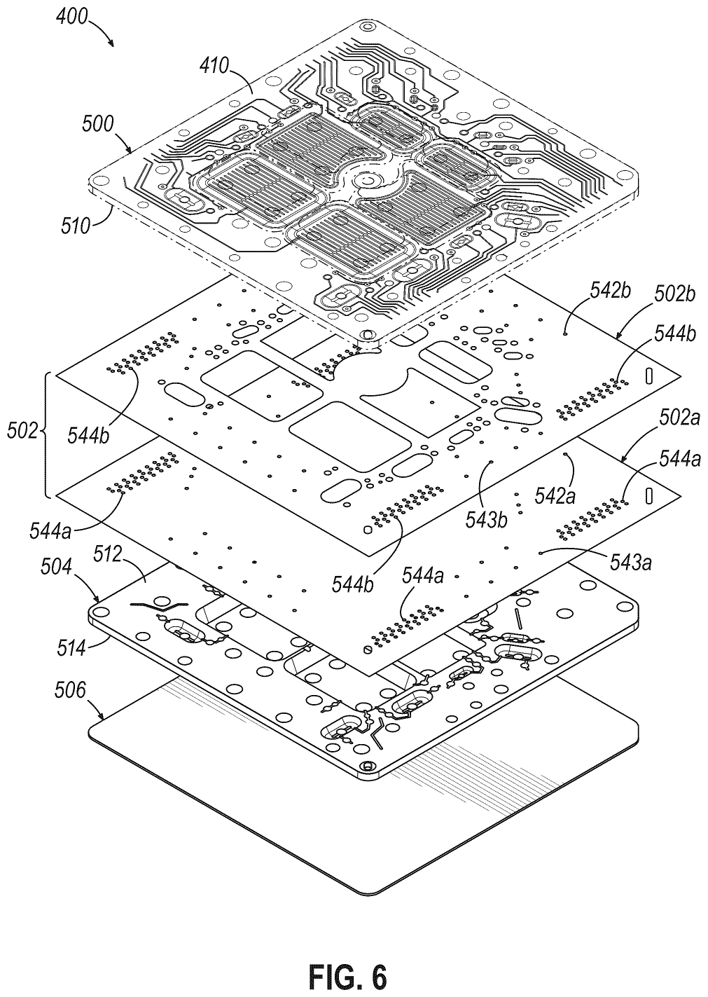

In the present example, fluid ports (421) and pressure ports (440) are all positioned on a top region of process chip (400), at least within the frame of reference of FIG. 6. In some other versions, fluid ports (421) are all positioned on a top region of process chip (400) while pressure ports (440) are all positioned on a bottom region of process chip (400). In some other versions, fluid ports (421) are all positioned on a bottom region of process chip (400) while pressure ports (440) are all positioned on a top region of process chip (400). As yet another variation, some fluid ports (421) may be positioned on a top region of process chip (400) while other fluid ports (421) are positioned on a bottom region of process chip (400). Similarly, some pressure ports (440) may be positioned on a top region of process chip (400) while other pressure ports (440) are positioned on a bottom region of process chip (400). In addition, or alternatively, some pressure ports (440) may be positioned directly above or directly below the corresponding chambers (424, 425, 430, 434, 450, 452, 460, 462, 464, 470) (e.g., rather than being positioned along one or more sides of process chip (400) and spaced apart from the corresponding chambers (424, 425, 430, 434, 450, 452, 460, 462, 464, 470)). In some versions, pressure ports (440) arranged in this manner may be directly fluidically coupled with the corresponding chambers (424, 425, 430, 434, 450, 452, 460, 462, 464, 470) (e.g., rather than be fluidically coupled with the corresponding chambers (424, 425, 430, 434, 450, 452, 460, 462, 464, 470) via respective pressure channels (444)).

Process chip (400) may also include electrical contacts, pins, pin sockets, capacitive coils, inductive coils, or other features that are configured to provide electrical communication with other components of system (100). In this regard, process chip (400) may include an electrically active region (not shown), similar to electrically active region (212), that includes such electrical communication features.

As shown in FIG. 6, process chip (400) further includes a first plate (500), an elastic layer (502), a second plate (504), and a third plate (506). As described in greater detail below, some versions of elastic layer (502) are in the form of a flexible membrane. First plate (500) has an upper surface (410) and a lower surface (510), with lower surface (510) apposing elastic layer (502). Second plate (504) has an upper surface (512) and a lower surface (514), with upper surface (512) apposing elastic layer (502); and with lower surface (514) apposing third plate (506). Elastic layer (502) is thus interposed between first and second plates (500, 504). Another elastic layer (not shown) similar to elastic layer (316) may also be interposed between second and third plates (504, 506).

Plates (500, 504, 506) of the present example are substantially translucent to visible light and/or ultraviolet light. By “substantially translucent” is meant that at least 90% (including in some instances 100%) of light is transmitted through the material compared to a translucent material. In some variations, the one or more of plates (500, 504, 506) may comprise materials that are substantially transparent to visible light and/or ultraviolet light. By “substantially transparent” is meant that at least 90% (including in some instances 100%) of light is transmitted through the material compared to a completely transparent material. As another example, one or more of plates (500, 504, 506) may provide transmission of ultraviolet light at a wavelength of approximately 260 nm at a transmission rate ranging from approximately 0.2% to approximately 20%, including from approximately 0.4% to approximately 15%, or including from approximately 0.5% to approximately 10%.

Plates (500, 504, 506) of the present example are also rigid. In some other versions, one or more of plates (500, 504, 506) are semi-rigid. Plates (500, 504, 506) may comprise glass, plastic, silicone, and/or any other suitable material(s). In some versions, one or more of plates (500, 504, 506) is formed as a lamination of two or more layers of material, such that each plate (500, 504, 506) does not necessarily need to be formed as a single homogenous continuum of material. The material(s) comprising one of plates (500, 504, 506) may also differ from the material(s) comprising other plates (500, 504, 506).

With continuing reference to FIG. 6, elastic layer (502) of the present example includes first and second liquid-impermeable flexible membranes (502a, 502b) laminated to each other in a vertically stacked arrangement. In the example shown, first flexible membrane (502a) is disposed below second flexible membrane (502b), with an upper surface of first flexible membrane (502a) apposing a lower surface of second flexible membrane (502b), though it will be appreciated that first flexible membrane (502a) may alternatively be disposed above second flexible membrane (502b), with a lower surface of first flexible membrane (502a) apposing an upper surface of second flexible membrane (502b). In some versions, one or both flexible membranes (502a, 502b) of elastic layer (502) is gas-permeable despite being liquid-impermeable. In some such versions, certain regions of the one or both flexible membranes (502a, 502b) of elastic layer (502) are treated to be gas-permeable while the non-treated regions of the one or both flexible membranes (502a, 502b) of elastic layer (502) are gas-impermeable.

As described below, elastic layer (502) may be used to drive fluids across process chip (400) via peristaltic pumping action. As also described below, elastic layer (502) may be used to provide valves at various locations along process chip (400). In some versions, a single sheet of elastic material spans across the width of process chip (200) to form first flexible membrane (502a) of elastic layer (302), and another single sheet of elastic material spans across the width of process chip (200) to form second flexible membrane (502b) of elastic layer (302). In some other versions, two or more discrete pieces of elastic material are used to form one or both of flexible membranes (502a, 502b) of elastic layer (302), with such discrete pieces of elastic material being positioned at different locations across the width of process chip (200). In still other versions, first and second flexible membranes (502a, 502b) may be integrally formed together with each other as a unitary piece. For example, a single sheet of elastic material may span across the width of process chip (200) and may have a varying thickness to form a single, unitary functional equivalent of both first and second flexible membranes (502a, 502b) of elastic layer (302). The varying thickness along the single, unitary piece may be provided using any suitable techniques, including but not limited to molding, machining, additive manufacturing, etc. By way of further example only, one or both flexible membranes (502a, 502b) of elastic layer (503) may comprise polydimethylsilicone (PDMS) elastomer film.

In some versions, each flexible membrane (502a, 502b) may have a thickness of about 100 μm, such that elastic layer (502) may have an overall thickness of about 200 μm. It will be appreciated that flexible membranes (502a, 502b) may have any other suitable thickness(es), and may have different thickness from each other. While first flexible membrane (502a) is shown disposed below second flexible membrane (502b) such that first flexible membrane (502a) may be referred to as lower flexible membrane (502a) and second flexible membrane (502b) may be referred to as upper flexible membrane (502b), first flexible membrane (502a) may alternatively be disposed above second flexible membrane (502b).

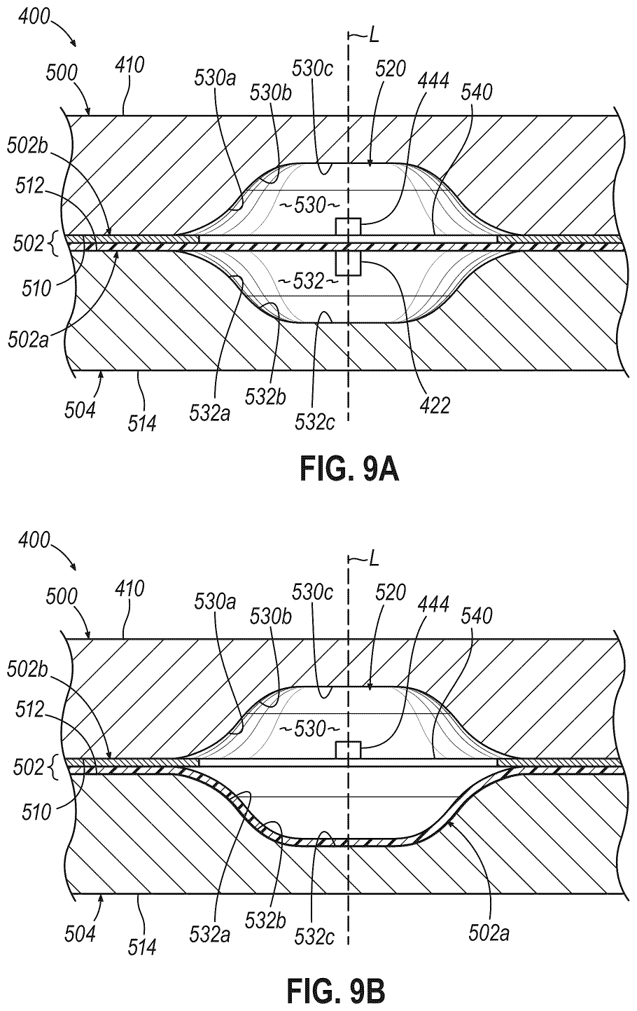

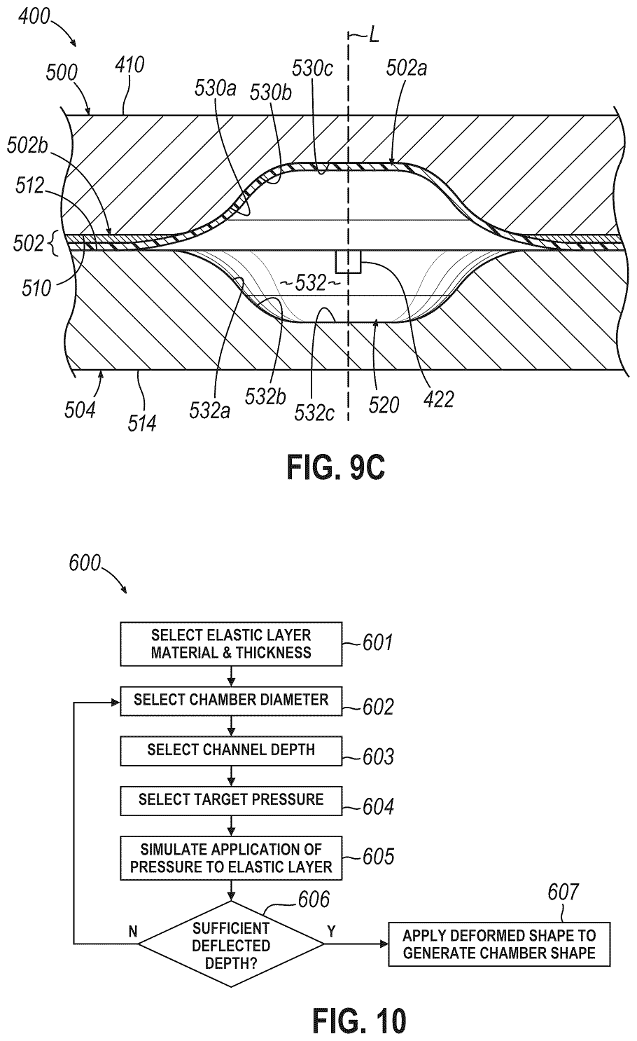

As best seen in FIGS. 9A-9C, first and second plates (500, 504) cooperate to define a plurality of chambers (520) (one shown), with first flexible membrane (502a) of elastic layer (502) bisecting each chamber (520) into a corresponding upper chamber region (530) and lower chamber region (532). As described in greater detail below, upper chamber region (530) receives pressurized gas while lower chamber region (532) receives fluids during operation of process chip (400). Upper chamber region (530) may thus be regarded as a “dry” chamber region; while lower chamber region (532) may be regarded as a “wet” chamber region. However, these “wet” and “dry” roles may be reversed in some variations. In other words, some variations of process chip (400) may provide pressurized gas to lower chamber region (532), such that lower chamber region (532) constitutes a “dry” chamber region; while upper chamber region (530) receives fluid, such that upper chamber constitutes a “wet” chamber region.

Any one or more of chambers (424, 425, 430, 434, 450, 452, 460, 462, 464, 470) shown in FIG. 5 may be configured and operable just like chamber (520) shown in FIGS. 9A-9C. For instance, chamber (520) may be analogous to any one or more of chambers (424, 425, 430, 434, 450, 452, 460, 462, 464, 470). In some versions, chamber (520) may be analogous to any one or more of valve chambers (424, 425, 434, 452, 462, 464). In this regard, chamber (520) may have a generally circular aerial profile (e.g., the profile of chamber (520) when viewed from above) and may extend vertically along a central longitudinal axis (L) that is oriented generally orthogonally relative to plates (500, 504). In some versions, chamber (520) may be configured to provide venting like a vacuum cap as described above. It should therefore be understood that chamber (520) may be configured to perform any of the functions of any of the fluid receiving regions of process chips (200, 400) described herein.

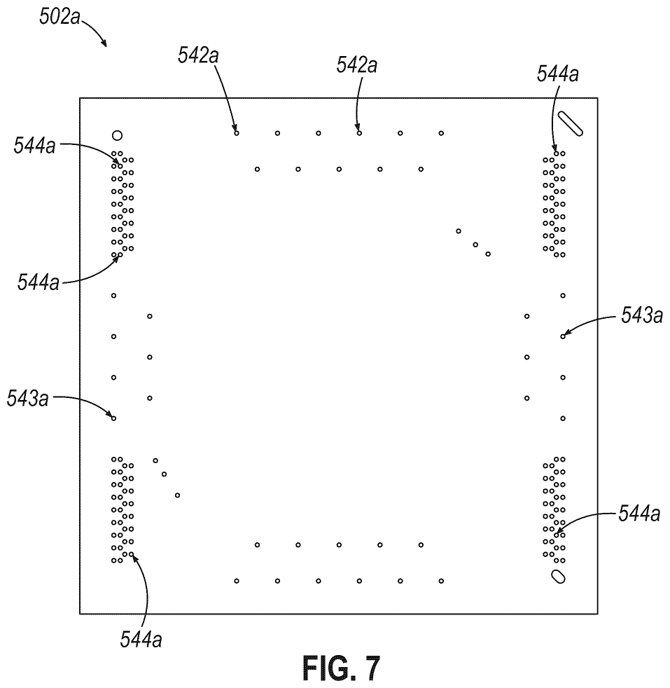

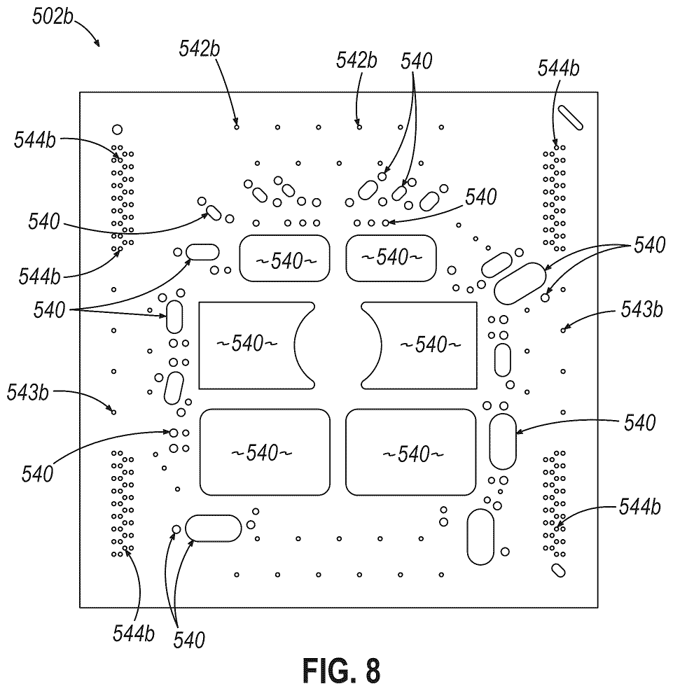

Fluid ports (420) may be formed through first plate (500) shown in FIG. 6. As shown in FIGS. 7 and 8, corresponding openings (542a, 542b) are formed through the regions of flexible membranes (502a, 502b) of elastic layer (502) underlying respective fluid ports (420). One of the fluid channels (422) extends from respective openings (542a, 542b) to lower chamber region (532) of chamber (520). As noted above, each fluid port (420) is configured to receive a fluid line (206) from fluid interface assembly (109). The distal end of fluid line (206) may be configured to seal against the region of elastic layer (502) that is exposed by fluid port (420) and communicate fluid through the respective openings (542a, 542b). In some versions, a spring or other resilient member provides a resilient bias to fluid line (206), urging the distal end of fluid line (206) against the region of elastic layer (502) that is exposed by fluid port (420) to thereby maintain the seal. Fluid from fluid line (206) reaches lower chamber region (532) of chamber (520) via fluid channel (422). As described in greater detail below, this fluid may be further communicated from chamber (520) to other chambers or other features in process chip (400), may be communicated to a storage vial in reagent storage frame (107), or may be otherwise processed through a peristaltic pumping action that is provided via elastic layer (502). It should also be understood that any of the other fluid ports (421, 466) shown in FIG. 5 may be configured and operable like fluid port (420). As shown in FIGS. 7 and 8, corresponding openings (543a, 543b) are formed through the regions of flexible membranes (502a, 502b) of elastic layer (502) underlying respective fluid ports (421, 466).

Pressure ports (440) may be formed through first plate (500) shown in FIG. 6. As shown in FIGS. 7 and 8, corresponding openings (544a, 544b) are formed through the regions of flexible membranes (502a, 502b) of elastic layer (502) underlying respective pressure ports (440). One of the pressure channels (444) extends from respective openings (544a, 544b) to upper chamber region (530) of first chamber (520). As noted above, each pressure port (440) is configured to receive a pressure line (208) from fluid interface assembly (109), to thereby receive pressurized gas from pressure source (117). The distal end of pressure line (208) is configured to seal against the region of elastic layer (502) that is exposed by pressure port (440) and communicate either positively pressurized gas or negatively pressurized gas through the respective openings (544, 544b). In some versions, a spring or other resilient member provides a resilient bias to pressure line (208), urging the distal end of pressure line (208) against the region of elastic layer (502) that is exposed by pressure port (440) to thereby maintain the seal. Positively pressurized gas or negatively pressurized gas from pressure line (208) reaches upper chamber region (530) of chamber (520) via pressure channel (444).

It will be appreciated that just one pressure line (208) may be coupled with process chip (400), or process chip (400) may have several coupled pressure lines (208), with such pressure lines (208) independently applying positive or negative pressure to corresponding chambers (520) of process chip (400). In some versions, one or more of chambers (520) has its own dedicated pressure line (208) and corresponding pressure channel (444). In addition, or in the alternative, one or more of chambers (520) may share a common pressure line (208), via the same pressure channel (444) or via separate pressure channels (444). In some versions, pressure channel (444) may be formed through second plate (504). In addition, or alternatively, some pressure channels (444) (or regions of pressure channels (444)) may be formed by first plate (500). For instance, some pressure channels (444) (or regions of pressure channels (444)) may be formed between a recess in the lower surface of first plate (500) and the top surface of elastic layer (502).

As noted above, first flexible membrane (502a) of elastic layer (502) bisects each chamber (520) by extending entirely across each chamber (520) at or near a vertical midpoint thereof to thereby fluidically isolate the corresponding upper and lower chamber regions (530, 532) from each other, at least when elastic layer (502) is in an undeflected state. In this regard, first flexible membrane (502a) of elastic layer (502) may be configured and operable similarly to elastic layer (302) described above, though first flexible membrane (502a) may in some versions have a lesser thickness than that of elastic layer (302). For example, first flexible membrane (502a) of elastic layer (502) may be configured to deflect within each chamber (520) to drive one or more fluids through each chamber (520) in a manner similar to that described above in connection with FIGS. 4A-4F.

Conversely, second flexible membrane (502b) of elastic layer (502) does not bisect or otherwise extend across at least one chamber (520), and is not configured to deflect within the at least one chamber (520). In some versions, second flexible membrane (502b) of elastic layer (502) may not bisect or otherwise extend across any of chambers (520), and may not be configured to deflect within any of chambers (520). In this regard, second flexible membrane (502b) of elastic layer (502) may be substantially identical to first flexible membrane (502a) (e.g., when viewed from above), except that second flexible membrane (502b) further includes a plurality of apertures (e.g., cutouts) (540) that are each configured to vertically align with a respective chamber (520), such that each aperture (540) is generally centered relative to the respective longitudinal axis (L). For example, each aperture (540) may be disposed directly below the corresponding upper chamber region (530) and/or directly above the corresponding lower chamber region (532). FIG. 8 best shows cutouts in second flexible membrane (502b) of elastic layer (502).

Each aperture (540) may be sized and shaped similarly to the respective chamber (520) (e.g., when viewed from above), such that a periphery of each aperture (540) may generally track a periphery of the respective chamber (520). For example, each aperture (540) that corresponds to a chamber (520) having a generally circular aerial profile (e.g., with the corresponding chamber (520) being analogous to any one or more of valve chambers (424, 425, 434, 452, 462, 464)) may also have a generally circular aerial profile; each aperture (540) that corresponds to a chamber (520) having a generally obround aerial profile (e.g., with the corresponding chamber (520) being analogous to any one or more of reservoir chambers (460)) may also have a generally obround aerial profile; each aperture (540) that corresponds to a chamber (520) having a generally rectangular aerial profile with rounded corners (e.g., with the corresponding chamber (520) being analogous to any one or more of chambers (430, 470)) may also have a generally rectangular aerial profile with rounded corners; and each aperture (540) that corresponds to a chamber (520) having a generally rectangular aerial profile with a concave side (e.g., with the corresponding chamber (520) being analogous to any one or more of chambers (450)) may also have a generally rectangular aerial profile with a concave side. In this manner, each aperture (540) of second flexible membrane (502b) may directly overlie or directly underlie a corresponding portion of first flexible membrane (502a) that is configured to deflect within the respective chamber (520). Apertures (540) may thereby accommodate deflection of first flexible membrane (502a) by preventing second flexible membrane (502b) of elastic layer (502) from forming wrinkles or otherwise interfering with the deflection of first flexible membrane (502a) of elastic layer (502) within chambers (520).

In some versions, one or more apertures (540) may extend partially into the respective chamber (520). For example, the periphery of each aperture (540) may be disposed inwardly of the periphery of the respective chamber (520) by at least about 50 μm. As another example, the periphery of each aperture (540) may be disposed inwardly of the periphery of the respective chamber (520) by at least about 200 μm. Such spacing may assist in ensuring proper bonding between elastic layer (502) and plate (500) in the region surrounding the respective chamber (520).

It should be understood from the foregoing that the combination of flexible membranes (502a, 502b) may provide higher thickness of elastic layer (502) in the regions where elastic layer (502) maintains constant interfaces with plates (500), thereby serving a desire to enhance the bond at these interfaces. In addition, the presence of apertures (540) and flexible membrane (502a) in the region of chamber (520) may provide a lower thickness of elastic layer (502) in the region of chamber (520), thereby serving a desire to enhance the effectiveness of valving and peristaltic pumping in chamber (520) (which, as noted above, may be configured as any one or more of a valve chamber, a synthesis chamber, a purification chamber, a mixing chamber, a metering chamber, a vacuum cap, or any other kind of fluid receiving region in a process chip (200, 400)). In other words, elastic layer (502) may simultaneously serve two desires that would otherwise seem to conflict with each other.

As shown in FIGS. 9A-9C, upper chamber region (530) and lower chamber region (532) of chamber (520) are each contoured to exhibit a generally flattened bell-shaped cross-sectional profile. More particularly, upper chamber region (530) is defined by a generally annular radially outer surface (530a), a generally annular radially intermediate surface (530b), and a generally circular radially inner surface (530c). Outer and intermediate surfaces (530a, 530b) are each curved, while inner surface (530c) is flat. In this regard, outer surface (530a) extends radially inwardly and upwardly from the radially outer periphery of chamber (520) on a first side of longitudinal axis (L) in a convex manner; intermediate surface (530b) extends radially inwardly and upwardly from a radially inward end of outer surface (530a) in a concave manner, such that outer and intermediate surfaces (530a, 530b) collectively exhibit a generally S-shaped cross-sectional profile (e.g., in the frame of reference of FIGS. 9A-9C) on the first side of longitudinal axis (L); inner surface (530c) extends generally parallel to surfaces (410, 510, 512, 514) of plates (500, 504) and/or generally parallel to flexible membranes (502a, 502b) of elastic layer (502) from a radially inward end of intermediate surface (530b) across longitudinal axis (L), such that inner surface (530c) is generally centered relative to longitudinal axis (L); intermediate surface (530b) extends radially outwardly and downwardly from an end of inner surface (530c) on a second side of longitudinal axis (L) in a concave manner; and outer surface (530a) extends radially outwardly and downwardly from a radially outward end of intermediate surface (530b) in a convex manner, such that outer and intermediate surfaces (530a, 530b) collectively exhibit a generally backwards S-shaped cross-sectional profile (e.g., in the frame of reference of FIGS. 9A-9C) on the second side of longitudinal axis (L).

As mentioned above, inner surface (530c) is circular, and is generally centered relative to longitudinal axis (L). Outer and intermediate surfaces (530a, 530b) may also each be generally centered relative to longitudinal axis (L), and may each have circumferentially uniform configurations relative to longitudinal axis (L), such that upper chamber region (530) may be generally symmetrical relative to the longitudinal axis (L). For example, outer surface (530a) may have a constant radius of curvature and/or a constant arclength, while intermediate surface (530b) may also have a constant radius of curvature and/or a constant arclength. In some versions, outer surface (530a) may have a first radius of curvature and/or a first arclength, while intermediate surface (530b) may have a second radius of curvature different from the first radius of curvature and/or a second arclength different from the first arclength.

Similarly, lower chamber region (532) is defined by a generally annular radially outer surface (532a), a generally annular radially intermediate surface (532b), and a generally circular radially inner surface (532c). Outer and intermediate surfaces (532a, 532b) are each curved, while inner surface (532c) is flat. In this regard, outer surface (532a) extends radially inwardly and downwardly from the radially outer periphery of chamber (520) on the first side of longitudinal axis (L) in a convex manner; intermediate surface (532b) extends radially inwardly and downwardly from a radially inward end of outer surface (532a) in a concave manner, such that outer and intermediate surfaces (532a, 532b) collectively exhibit a generally backwards S-shaped cross-sectional profile (e.g., in the frame of reference of FIGS. 9A-9C) on the first side of longitudinal axis (L); inner surface (532c) extends generally parallel to surfaces (410, 510, 512, 514) of plates (500, 504) and/or generally parallel to flexible membranes (502a, 502b) of elastic layer (502) from a radially inward end of intermediate surface (532b) across longitudinal axis (L), such that inner surface (532c) is generally centered relative to longitudinal axis (L); intermediate surface (532b) extends radially outwardly and upwardly from an end of inner surface (532c) on the second side of longitudinal axis (L) in a concave manner; and outer surface (532a) extends radially outwardly and upwardly from a radially outward end of intermediate surface (532b) in a convex manner, such that outer and intermediate surfaces (532a, 532b) collectively exhibit a generally S-shaped cross-sectional profile (e.g., in the frame of reference of FIGS. 9A-9C) on the second side of longitudinal axis (L).

As mentioned above, inner surface (532c) is circular, and is generally centered relative to longitudinal axis (L). Outer and intermediate surfaces (532a, 532b) may also each be generally centered relative to longitudinal axis (L), and may each have circumferentially uniform configurations relative to longitudinal axis (L), such that lower chamber region (532) may be generally symmetrical relative to the longitudinal axis (L). For example, outer surface (532a) may have a constant radius of curvature and/or a constant arclength, while intermediate surface (532b) may also have a constant radius of curvature and/or a constant arclength. In some versions, outer surface (532a) may have a first radius of curvature and/or a first arclength, while intermediate surface (532b) may have a second radius of curvature different from the first radius of curvature and/or a second arclength different from the first arclength.

In addition, or alternatively, chamber (520) may be generally symmetrical relative to elastic layer (502). For example, outer surface (532a) of lower chamber region (532) may have a same radius of curvature, arclength, outer diameter, and/or inner diameter as outer surface (530a) of upper chamber region (530); intermediate surface (532b) of lower chamber region (532) may have a same radius of curvature, arclength, outer diameter, and/or inner diameter as intermediate surface (530b) of upper chamber region (530); and/or inner surface (532c) of lower chamber region (532) may have a same diameter as inner surface (530c) of upper chamber region (530). In some other versions, chamber (520) may be generally asymmetrical relative to elastic layer (502). For example, one of the upper or lower chamber regions (530, 532), such as lower chamber region (532), may have the illustrated flattened bell-shaped cross-sectional profile, while the other of the upper or lower chamber regions (530, 532), such as upper chamber region (530), may have an entirely different cross-sectional profile, such as an arcuate cross-sectional profile, a semi-circular cross-sectional profile, a rectangular cross-sectional profile, etc.

As noted above, elastic layer (502) may be operated to drive fluid through process chip (400) through a peristaltic pumping action; and to arrest movement of fluid through process chip (400) by providing a valving action. An example of such operation is illustrated in the sequence depicted through FIGS. 9A-9C. In this example, chamber (520) serves as a valve chamber (e.g., with chamber (520) being analogous to any one or more of valve chambers (424, 425, 434, 452, 462, 464)). This configuration, arrangement, and usage of chamber (520) is provided as an illustrative example. Chamber (520) may alternatively be configured, arranged, and used in other ways (e.g., with chamber (520) being analogous to any one or more of reservoir chambers (460) and/or chambers (430, 450, 470)).

FIG. 9A shows process chip (400) in a state where fluid is not yet being communicated to process chip (400); and pressurized gas is not yet being communicated to process chip (400). In FIG. 9B, positively pressurized gas is communicated to upper chamber region (530) of chamber (520). In this state, the positively pressurized gas deforms the portion of first flexible membrane (502a) of elastic layer (502) in chamber (520) such that first flexible membrane (502a) of elastic layer (502) fully seats against surfaces (532a, 532b, 532c) of lower chamber region (532) of chamber (520). This seating of first flexible membrane (502a) of elastic layer (502) against surfaces (532a, 532b, 532c) of lower chamber region (532) of chamber (520) prevents fluid from entering chamber (520), such that chamber (520) is operating like a closed valve in the state shown in FIG. 9B.

In FIG. 9C, negatively pressurized gas is communicated to upper chamber region (530) of chambers (520). In this state, the negatively pressurized gas in upper chamber region (530) of chamber (520) causes the corresponding portion of first flexible membrane (502a) of elastic layer (502) in chamber (520) to deform and fully seat against surfaces (530a, 530b, 530c) of upper chamber region (530) of chamber (520). This effectively opens the valve formed by chamber (520) and puts chamber (520) in a state to receive fluid (not shown) and allow the fluid to occupy the full capacity of chamber (520). Positively pressurized gas may then be communicated to upper chamber region (530) of chamber (520) to deform the first flexible membrane (502a) back to the state shown in FIG. 9B, thereby driving any fluid from chamber (520).

As mentioned above, first flexible membrane (502a) of elastic layer (502) may have a lesser thickness than that of elastic layer (302) described above. Due to the presence of apertures (540) in the regions of elastic layer (502) that are disposed within chambers (520), elastic layer (502) may be thinner than elastic layer (302) in such regions to thereby provide an improved response of such regions of elastic layer (502) to pneumatic pressure. For example, elastic layer (502) may provide improved valving and/or pumping action, at least by comparison to elastic layer (302). In addition, or alternatively, the valving and/or pumping action provided by elastic layer (502) may be achieved via a reduced pneumatic pressure, at least by comparison to that needed for pneumatically actuating elastic layer (302). Such reduced pneumatic pressure may be relatively easy to maintain and/or provide improved safety. The ability of elastic layer (502) to be pneumatically actuated at a reduced pneumatic pressure may also allow any one or more of chambers (424, 425, 430, 434, 450, 452, 460, 462, 464, 470) to have a reduced size, at least by comparison to chambers (224, 225, 230, 234, 250, 252, 260, 262, 264, 270), thereby conserving space on process chip (400). In some versions, the valving and/or pumping action provided by elastic layer (502) may be achieved via a pneumatic pressure of about 5-6 psi. As another example, the valving and/or pumping action provided by elastic layer (502) may be achieved via a pneumatic pressure of about 4 psi.

In addition, or alternatively, first flexible membrane (502a) and second flexible membrane (502b) may collectively have a greater overall thickness than that of elastic layer (302) described above. Due to the absence of apertures (540) in the regions of elastic layer (502) that are bonded to first and/or second plates (500, 504), elastic layer (502) may be thicker than elastic layer (302) in such regions to thereby provide an improved seal between such regions of elastic layer (502) and one or both of first and/or second plates (500, 504). For example, the upper and lower surfaces of elastic layer (502) may exhibit improved conformity to the respective apposed surfaces (510, 512) of plates (500, 504), at least by comparison to elastic layer (302). In addition, or alternatively, the upper and lower surfaces of elastic layer (502) may exhibit decreased susceptibility to deforming into any of channels (422, 423, 444), chambers (424, 425, 430, 434, 450, 452, 460, 462, 464, 470), and/or other microfluidic path features of process chip (400) during assembly of process chip (400), at least by comparison to elastic layer (302). In this regard, a ratio of the thickness of elastic layer (502) to a width of any of channels (422, 423, 444) may be about 1:2 or greater. In other words, the relationship between the thickness of elastic layer (502) and the width of any of channels (422, 423, 444) may be expressed as:

$$\frac{t}{w} \geq 0.5$$

where t=the thickness of elastic layer (502), and w=the width of a channel (422, 423, 444).

For example, elastic layer (502) may have a thickness of about 200 μm, and any of channels (422, 423, 444) may have a width of about 400 μm. In some versions, process chip (400) may be assembled by first adhering flexible membranes (502a, 502b) to the respective plates (500, 504), and then adhering flexible membranes (502a, 502b) to each other (e.g., with first plate (500) and first flexible membrane (502a) disposed above second flexible membrane (502b) and second plate (504)).

It will be appreciated that the flattened bell shape of upper chamber region (530) and lower chamber region (532) of chamber (520) may provide improved manufacturability of the respective plate(s) (500, 504), such as by enabling molding of the respective plate(s) (500, 504). In addition, or alternatively, the shape of upper chamber region (530) and lower chamber region (532) of chamber (520) may provide the regions of elastic layer (502) that are disposed within chambers (520) with an improved pneumatic pressure response, such as by allowing such regions to more closely conform to the respective surfaces (530a, 530b, 530c, 532a, 532b, 532c) of chamber regions (530, 532) and thereby more fully seat against the respective surfaces (530a, 530b, 530c, 532a, 532b, 532c) in response to pneumatic pressure (e.g., provided via pressure line (208)), at least by comparison to the surfaces of chamber regions (330, 332).

In some cases, each surface (530a, 530b, 530c, 532a, 532b, 532c) may avoid contorting such regions of elastic layer (502) when such regions of elastic layer (502) are seated thereagainst. In this regard, surfaces (530a, 530b, 530c, 532a, 532b, 532c) may be sized and configured based on a predetermined deformed shape of such regions of elastic layer (502) in response to a predetermined pneumatic pressure. For example, the deformed shape of a particular region of elastic layer (502) may be determined by simulating deformation of the region of elastic layer (502) in response to the predetermined pneumatic pressure. Surfaces (530a, 530b, 530c) of upper chamber region (530) and/or surfaces (532a, 532b, 532c) of lower chamber region (532) may then be sized and configured to collectively match (e.g., complement) the deformed shape of the corresponding region of elastic layer (502). This may provide precise seating of the corresponding regions of elastic layer (502) against surfaces (530a, 530b, 530c, 532a, 532b, 532c) in response to pneumatic pressure while reducing or eliminating any contortion of such regions of elastic layer (502) by surfaces (530a, 530b, 530c, 532a, 532b, 532c). As a result, surfaces (530a, 530b, 530c, 532a, 532b, 532c) may provide improved sealing with elastic layer (502) and/or may achieve sufficient sealing with elastic layer (502) at a reduced pneumatic pressure.

FIG. 10 shows an example of a method (600) for designing chamber (520). While method (600) is described in the context of designing chamber (520) to be used for a valving operation, it will be appreciated that method (600) may also be used to design chamber (520) to be used for a pumping operation.

Method (600) begins with step (601), at which a material and thickness of an elastic layer, such as elastic layer (302) or elastic layer (502), are selected. For example, the material may be selected as PDMS, and/or the thickness may be selected as about 200 μm. In cases using elastic layer (502), the material and/or thickness of elastic layer (502) that is selected at step (601) may be the material and/or thickness of first flexible membrane (502a) of elastic layer (502). Method (600) proceeds from step (601) to step (602), at which a diameter of a chamber, such as chamber (520), is selected. For example, the diameter may be selected as about 2.1 mm. Method (600) proceeds from step (602) to step (603), at which a depth of an adjoining channel, such as channel (422), is selected. For example, the depth may be selected as about 200 μm. Method (600) proceeds from step (603) to step (604), at which a target pressure for actuating the elastic layer (e.g. to close the chamber) is selected. For example, the target pressure may be selected as about 4 psi.

Method (600) proceeds from step (604) to step (605), at which the application of increasing pressure to the elastic layer is simulated. For example, the application of pressure increasing from about 0 psi to about 15 psi to the elastic layer may be simulated. Method (600) proceeds from step (605) to step (606), whereat it is determined whether the deflected depth of the elastic layer as simulated at the target pressure is sufficient to perform the desired valving operation (e.g., by being capable of closing the adjoining channel). For example, the deflected depth of the elastic layer may be determined to be sufficient if the deflected depth of the elastic layer is equal to or greater than a predetermined threshold, such as a value that is approximately equal to twice the depth of the adjoining channel (e.g., about 400 μm). If the deflected depth of the elastic layer is determined to not be sufficient, then method may return from step (606) to step (602), at which a larger chamber diameter may be selected. If the deflected depth of the elastic layer is determined to be sufficient, then method proceeds from step (606) to step (607), at which the deformed shape of the elastic layer as simulated at the target pressure is applied to generate a shape of the chamber, such as the shape of upper and/or lower chamber region (530, 532) of chamber (520). For example, the particular sizes and configurations of surfaces (530a, 530b, 530c, 532a, 532b, 532c) may be generated based on the deformed shape of the elastic layer as simulated at the target pressure.

The particular sizes and configurations of surfaces (530a, 530b, 530c, 532a, 532b, 532c) that are based on a predetermined pneumatic pressure may be scaled (e.g., up or down) according to various other parameters of process chip (400), such as the depth of any of channels (422, 423, 444) and/or the thickness of first flexible membrane (502a) of elastic layer (502), for example. Thus, the flattened bell shape of upper and/or lower chamber region (530, 532) may be fine tuned for different applications.

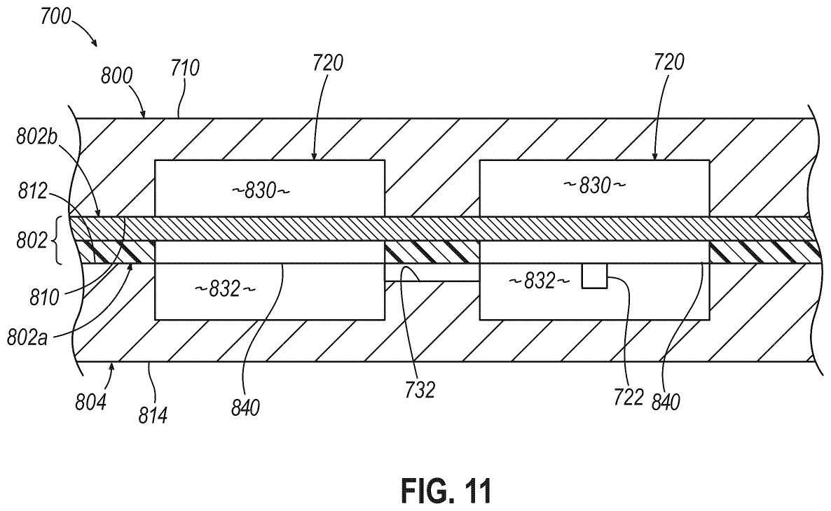

FIG. 11 shows another example of a process chip (700) that is similar to process chip (400) described above, except as otherwise described below. As shown, process chip (700) includes a first plate (800), an elastic layer (802), and a second plate (804). First plate (800) has an upper surface (710) and a lower surface (810), with lower surface (810) apposing elastic layer (802). Second plate (804) has an upper surface (812) and a lower surface (814), with upper surface (812) apposing elastic layer (802). Elastic layer (802) is thus interposed between first and second plates (800, 804). Elastic layer (802) of the present example includes first and second liquid-impermeable flexible membranes (802a, 802b) laminated to each other in a vertically stacked arrangement. First flexible membrane (802a) may be referred to as lower flexible membrane (802a) and second flexible membrane (802b) may be referred to as upper flexible membrane (802b). First and second plates (800, 804) cooperate to define a plurality of chambers (720), with second flexible membrane (802b) of elastic layer (802) bisecting each chamber (820) into a corresponding upper chamber region (830) and lower chamber region (832). Fluid may be communicated between at least one lower chamber region (832) and one or more fluid ports (not shown) via an associated fluid channel (722), and may be communicated from one lower chamber region (832) to another lower chamber region (832) via a fluid channel (732).

In the example shown, first flexible membrane (802a) of elastic layer (802) is substantially identical to second flexible membrane (802b) (e.g., when viewed from above), except that first flexible membrane (802a) further includes a plurality of apertures (e.g., cutouts) (840) that are each configured to vertically align with a respective chamber (820). For example, each aperture (840) may be disposed directly below the corresponding upper chamber region (830) and/or directly above the corresponding lower chamber region (832).

Thus, unlike the example shown in FIGS. 5-9C where apertures (540) are incorporated into second flexible membrane (502b), FIG. 11 shows apertures (840) incorporated into first flexible membrane (502a). In some variations, apertures (840) may be incorporated into both flexible membranes (802a, 802b) at different locations on elastic layer (802) that correspond to different chambers (820). For example, first flexible membrane (802a) may include an aperture (840) that is vertically aligned with a first chamber (820), while second flexible membrane (802b) may not include an aperture (840) that is vertically aligned with the first chamber (820); and second flexible membrane (802b) may include an aperture (840) that is vertically aligned with a second chamber (820), while first flexible membrane (802a) may not include an aperture (840) that is vertically aligned with the second chamber (820). In other words, apertures (840) may alternate between being incorporated into first flexible membrane (802a) or second flexible membrane (802b).

### VI. Examples of Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A microfluidic apparatus comprising: (a) a first plate; (b) a second plate; (c) a microfluidic path defined between the first plate and the second plate, the microfluidic path comprising at least one chamber; and (d) an elastic layer disposed between the first plate and the second plate, the elastic layer including: (i) a first membrane extending across the at least one chamber, the first membrane being configured to deflect to drive a fluid through the at least one chamber, and (ii) a second membrane having at least one aperture, the at least one aperture being aligned with the at least one chamber.

### Example 2

The microfluidic apparatus of Example 1, the second membrane not extending across the at least one chamber.

### Example 3

The microfluidic apparatus of any of Examples 1 through 2, the at least one chamber extending along a central longitudinal axis, the at least one aperture being centered relative to the central longitudinal axis.

### Example 4

The microfluidic apparatus of any of Examples 1 through 3, the first membrane being configured to fluidically isolate a first region of the at least one chamber from a second region of the at least one chamber.

### Example 5

The microfluidic apparatus of Example 4, the at least one aperture being disposed directly above the first region and directly below the second region.

### Example 6

The microfluidic apparatus of any of Examples 1 through 5, the first and second membranes being laminated to each other.

### Example 7

The microfluidic apparatus of any of Examples 1 through 6, one of the first or second membranes being adhered to the first plate, the other of the first or second membranes being adhered to the second plate.

### Example 8

The microfluidic apparatus of any of Examples 1 through 7, at least one of the first or second membranes comprising polydimethylsilicone (PDMS).

### Example 9

The microfluidic apparatus of any of Examples 1 through 8, at least one of the first or second membranes having a thickness of about 100 μm.

### Example 10

The microfluidic apparatus of any of Examples 1 through 9, the elastic layer having an overall thickness of about 200 μm.

### Example 11

The microfluidic apparatus of any of Examples 1 through 10, the at least one chamber and the at least one aperture having a same profile as each other.

### Example 12

The microfluidic apparatus of Example 11, the profile being at least one of circular, obround, or at least partially rectangular.

### Example 13

The microfluidic apparatus of any of Examples 1 through 12, the at least one chamber including a valve chamber.

### Example 14

The microfluidic apparatus of any of Examples 1 through 13, the at least one chamber including a plurality of chambers, the at least one aperture including a plurality of apertures, each aperture of the plurality of apertures being aligned with a corresponding chamber of the plurality of chambers.

### Example 15

The microfluidic apparatus of Example 14, the plurality of apertures having different profiles from each other.

### Example 16

A microfluidic apparatus comprising: (a) an upper plate; (b) a lower plate; (c) a microfluidic path defined between the upper plate and the lower plate, the microfluidic path comprising a chamber; and (d) an elastic layer disposed between the upper plate and the lower plate, the elastic layer including: (i) a first membrane bisecting the chamber to define an upper chamber region and a lower chamber region, the first membrane being configured to deflect to drive a fluid through the chamber, and (ii) a second membrane having an aperture, the aperture being disposed directly below the upper chamber region and directly above the lower chamber region.

### Example 17

The microfluidic apparatus of Example 16, the first and second membranes being laminated to each other.

### Example 18

The microfluidic apparatus of any of Examples 16 through 17, the first membrane being disposed below the second membrane.

### Example 19

The microfluidic apparatus of any of Examples 16 through 18, the chamber and the aperture having a same profile as each other.

### Example 20

A microfluidic apparatus comprising: (a) a first plate; (b) a second plate; (c) a microfluidic path defined between the first plate and the second plate, the microfluidic path comprising a chamber; and (d) an elastic layer disposed between the first plate and the second plate, the elastic layer including: (i) a first membrane configured to fluidically isolate a first region of the chamber from a second region of the chamber, the first membrane being configured to deflect to drive a fluid through the chamber, and (ii) a second membrane having an aperture, the aperture being aligned with the chamber.

### Example 21

A microfluidic apparatus comprising: (a) a first plate; (b) a second plate; (c) an elastic layer disposed between the first plate and the second plate; and (d) a microfluidic path defined between the first plate and the second plate, the microfluidic path comprising a chamber, the chamber extending along a central longitudinal axis, at least a portion of the chamber having a flattened bell-shaped cross-sectional profile.

### Example 22

The microfluidic apparatus of Example 21, the elastic layer extending across the chamber to define first and second regions of the chamber, at least one of the first or second regions having the flattened bell-shaped cross-sectional profile.

### Example 23

The microfluidic apparatus of Example 22, each of the first and second regions having the flattened bell-shaped cross-sectional profile.

### Example 24

The microfluidic apparatus of any of Examples 21 through 23, the chamber being generally symmetrical relative to the central longitudinal axis.

### Example 25

The microfluidic apparatus of any of Examples 21 through 24, the chamber including a radially inner surface, a radially outer surface, and a radially intermediate surface collectively defining the flattened bell-shaped cross-sectional profile.

### Example 26

The microfluidic apparatus of Example 25, the radially inner surface having a flat cross-sectional profile.

### Example 27

The microfluidic apparatus of any of Examples 25 through 26, the radially outer surface and the radially intermediate surface each having a curved cross-sectional profile.

### Example 28

The microfluidic apparatus of Example 27, the radially outer surface having a convex cross-sectional profile.

### Example 29

The microfluidic apparatus of any of Examples 27 through 28, the radially intermediate surface having a concave cross-sectional profile.

### Example 30

The microfluidic apparatus of any of Examples 27 through 29, the radially outer surface and the radially intermediate surface collectively defining at least one of an S-shaped or a backwards S-shaped cross-sectional profile.

### Example 31

The microfluidic apparatus of any of Examples 25 through 30, the radially inner surface being generally circular.

### Example 32

The microfluidic apparatus of Example 31, the radially outer surface and the radially intermediate surface each being generally annular.

### Example 33

The microfluidic apparatus of any of Examples 25 through 32, a portion of the elastic layer being configured to deflect to drive a fluid through the chamber, the portion of the elastic layer being configured to conform to each of the radially inner surface, the radially outer surface, and the radially intermediate surface when deflected.

### Example 34

The microfluidic apparatus of Example 33, the elastic layer including: (i) a first membrane extending across the chamber, the first membrane being configured to deflect to drive the fluid through the chamber, the first membrane being configured to conform to each of the radially inner surface, the radially outer surface, and the radially intermediate surface when deflected, and (ii) a second membrane having an aperture, the aperture being aligned with the chamber.

### Example 35

The microfluidic apparatus of any of Examples 21 through 34, the chamber including a valve chamber.

### Example 36

A microfluidic apparatus comprising: (a) a first plate; (b) a second plate; (c) an elastic layer disposed between the first plate and the second plate; and (d) a microfluidic path defined between the first plate and the second plate, the microfluidic path comprising a chamber, the chamber extending along a central longitudinal axis, the chamber including: (i) a radially inner surface having a flat cross-sectional profile, (ii) a radially outer surface having a convex cross-sectional profile, and (iii) a radially intermediate surface having a concave cross-sectional profile.

### Example 37

The microfluidic apparatus of Example 36, the radially outer surface and the radially intermediate surface collectively defining at least one of an S-shaped or a backwards S-shaped cross-sectional profile.

### Example 38

The microfluidic apparatus of any of Examples 36 through 37, the radially inner surface being generally circular.

### Example 39

The microfluidic apparatus of Example 38, the radially outer surface and the radially intermediate surface each being generally annular.

### Example 40

A microfluidic apparatus comprising: (a) a first plate; (b) a second plate; (c) an elastic layer disposed between the first plate and the second plate; and (d) a microfluidic path defined between the first plate and the second plate, the microfluidic path comprising a chamber, the chamber extending along a central longitudinal axis, the chamber including: (i) a radially inner surface, (ii) a radially outer surface, and (iii) a radially intermediate surface, wherein: (A) the radially outer surface extends radially inwardly from a radially outer periphery of the chamber on a first side of the longitudinal axis in a convex manner, (B) the radially intermediate surface extends radially inwardly from a radially inward end of the radially outer surface in a concave manner on the first side of the longitudinal axis, (C) the radially inner surface extends generally parallel to the first and second plates from a radially inward end of the radially intermediate surface across the longitudinal axis to a second side of the longitudinal axis, (D) the radially intermediate surface extends radially outwardly from an end of the radially inner surface on the second side of the longitudinal axis in a concave manner, and (E) the radially outer surface extends radially outwardly from a radially outward end of the radially intermediate surface in a convex manner on the second side of the longitudinal axis

### VII. Miscellaneous

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Some versions of the examples described herein may be implemented using a processor, which may be part of a computer system and communicate with a number of peripheral devices via bus subsystem. Versions of the examples described herein that are implemented using a computer system may be implemented using a general-purpose computer that is programmed to perform the methods described herein. Alternatively, versions of the examples described herein that are implemented using a computer system may be implemented using a specific-purpose computer that is constructed with hardware arranged to perform the methods described herein. Versions of the examples described herein may also be implemented using a combination of at least one general-purpose computer and at least one specific-purpose computer.

In versions implemented using a computer system, each processor may include a central processing unit (CPU) of a computer system, a microprocessor, an application-specific integrated circuit (ASIC), other kinds of hardware components, and combinations thereof. A computer system may include more than one type of processor. The peripheral devices of a computer system may include a storage subsystem including, for example, memory devices and a file storage subsystem, user interface input devices, user interface output devices, and a network interface subsystem. The input and output devices may allow user interaction with the computer system. The network interface subsystem may provide an interface to outside networks, including an interface to corresponding interface devices in other computer systems. User interface input devices may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system.

In versions implemented using a computer system, a user interface output device may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide a non-visual display such as audio output devices. In general, use of the term “output device” is intended to include all possible types of devices and ways to output information from computer system to the user or to another machine or computer system.

In versions implemented using a computer system, a storage subsystem may store programming and data constructs that provide the functionality of some or all of the modules and methods described herein. These software modules may be generally executed by the processor of the computer system alone or in combination with other processors. Memory used in the storage subsystem may include a number of memories including a main random-access memory (RAM) for storage of instructions and data during program execution and a read only memory (ROM) in which fixed instructions are stored. A file storage subsystem may provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem in the storage subsystem, or in other machines accessible by the processor.

In versions implemented using a computer system, the computer system itself may be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the example of the computer system described herein is intended only as a specific example for purposes of illustrating the technology disclosed. Many other configurations of a computer system are possible having more or fewer components than the computer system described herein.

As an article of manufacture, rather than a method, a non-transitory computer readable medium (CRM) may be loaded with program instructions executable by a processor. The program instructions when executed, implement one or more of the computer-implemented methods described above. Alternatively, the program instructions may be loaded on a non-transitory CRM and, when combined with appropriate hardware, become a component of one or more of the computer-implemented systems that practice the methods disclosed.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1. A microfluidic apparatus comprising:
(a) a first plate;
(b) a second plate;
(c) a microfluidic path defined between the first plate and the second plate, the microfluidic path comprising at least one chamber; and
(d) an elastic layer disposed between the first plate and the second plate, the elastic layer including:
(i) a first membrane extending across the at least one chamber, the first membrane being configured to deflect to drive a fluid through the at least one chamber, and
(ii) a second membrane having at least one aperture, the at least one aperture being aligned with the at least one chamber.

2. The microfluidic apparatus of claim 1, the second membrane not extending across the at least one chamber.

3. The microfluidic apparatus of claim 1, the at least one chamber extending along a central longitudinal axis, the at least one aperture being centered relative to the central longitudinal axis.

4. The microfluidic apparatus of claim 1, the first membrane being configured to fluidically isolate a first region of the at least one chamber from a second region of the at least one chamber.

5. The microfluidic apparatus of claim 4, the at least one aperture being disposed directly above the first region and directly below the second region.

6. The microfluidic apparatus of claim 1, the first and second membranes being laminated to each other.

7. The microfluidic apparatus of claim 1, one of the first or second membranes being adhered to the first plate, the other of the first or second membranes being adhered to the second plate.

8. The microfluidic apparatus of claim 1, at least one of the first or second membranes comprising polydimethylsilicone (PDMS).

9. The microfluidic apparatus of claim 1, at least one of the first or second membranes having a thickness of about 100 μm.

10. The microfluidic apparatus of claim 1, the elastic layer having an overall thickness of about 200 μm.

11. The microfluidic apparatus of claim 1, the at least one chamber and the at least one aperture having a same profile as each other.

12-13. (canceled)

14. The microfluidic apparatus of claim 1, the at least one chamber including a plurality of chambers, the at least one aperture including a plurality of apertures, each aperture of the plurality of apertures being aligned with a corresponding chamber of the plurality of chambers.

15. (canceled)

16. A microfluidic apparatus comprising:
(a) an upper plate;
(b) a lower plate;
(c) a microfluidic path defined between the upper plate and the lower plate, the microfluidic path comprising a chamber; and
(d) an elastic layer disposed between the upper plate and the lower plate, the elastic layer including:
(i) a first membrane bisecting the chamber to define an upper chamber region and a lower chamber region, the first membrane being configured to deflect to drive a fluid through the chamber, and
(ii) a second membrane having an aperture, the aperture being disposed directly below the upper chamber region and directly above the lower chamber region.

17. The microfluidic apparatus of claim 16, the first and second membranes being laminated to each other.

18. The microfluidic apparatus of claim 16, the first membrane being disposed below the second membrane.

19-35. (canceled)

36. A microfluidic apparatus comprising:
(a) a first plate;
(b) a second plate;
(c) an elastic layer disposed between the first plate and the second plate; and
(d) a microfluidic path defined between the first plate and the second plate, the microfluidic path comprising a chamber, the chamber extending along a central longitudinal axis, the chamber including:
(i) a radially inner surface having a flat cross-sectional profile,
(ii) a radially outer surface having a convex cross-sectional profile, and
(iii) a radially intermediate surface having a concave cross-sectional profile.

37. The microfluidic apparatus of claim 36, the radially outer surface and the radially intermediate surface collectively defining at least one of an S-shaped or a backwards S-shaped cross-sectional profile.

38. The microfluidic apparatus of claim 36, the radially inner surface being generally circular.

39. The microfluidic apparatus of claim 38, the radially outer surface and the radially intermediate surface each being generally annular.

40. A microfluidic apparatus comprising:
(a) a fi-18, rst plate;
(b) a second plate;
(c) an elastic layer disposed between the first plate and the second plate; and
(d) a microfluidic path defined between the first plate and the second plate, the microfluidic path comprising a chamber, the chamber extending along a central longitudinal axis, the chamber including:
(i) a radially inner surface,
(ii) a radially outer surface, and
(iii) a radially intermediate surface,
wherein:
(A) the radially outer surface extends radially inwardly from a radially outer periphery of the chamber on a first side of the longitudinal axis in a convex manner,
(B) the radially intermediate surface extends radially inwardly from a radially inward end of the radially outer surface in a concave manner on the first side of the longitudinal axis,
(C) the radially inner surface extends generally parallel to the first and second plates from a radially inward end of the radially intermediate surface across the longitudinal axis to a second side of the longitudinal axis,
(D) the radially intermediate surface extends radially outwardly from an end of the radially inner surface on the second side of the longitudinal axis in a concave manner, and
(E) the radially outer surface extends radially outwardly from a radially outward end of the radially intermediate surface in a convex manner on the second side of the longitudinal axis.
